(19) United States
(12) Patent Application Publication
(10) Pub. No.: US 2008/0162305 A1
(43) Pub. Date: Jul. 3, 2008

(54) APPARATUSES, METHODS AND SYSTEMS FOR A PRODUCT MANIPULATION AND MODIFICATION INTERFACE

(76) Inventors: Armand Rousso, Jersey City, NY (US); Joseph Sorisi, Old Brookville, NY (US); Guy Praisler, Edgewater, NJ (US); Kevin Dorry, Sparta, NJ (US); Ronald Wilkins, Brooklyn, NY (US); David Walker, Norwood, NJ (US)

Correspondence Address: CHADBOURNE & PARKE LLP, 30 ROCKEFELLER PLAZA, NEW YORK, NY, 10112, US

(21) Appl. No.: 11/864,903

(22) Filed: Sep. 28, 2007

Related U.S. Application Data
(60) Provisional application No. 60/827,683, filed on Sep. 29, 2006.
(60) Provisional application No. 60/827,687, filed on Sep. 29, 2006.
(60) Provisional application No. 60/827,684, filed on Sep. 29, 2006.
(60) Provisional application No. 60/870,561, filed on Dec. 18, 2006.
(60) Provisional application No. 60/827,688, filed on Sep. 29, 2006.
(60) Provisional application No. 60/827,686, filed on Sep. 29, 2006.
(60) Provisional application No. 60/913,521, filed on Apr. 23, 2007.

(51) Int. Cl. G06Q 30/00

(52) U.S. Cl. 705/27; 705/26

(57) ABSTRACT

The disclosure details the implementation of apparatuses, methods and systems for a product manipulation and modification interface. Described herein are functionalities facilitating online procurement, shopping, transacting, editing and/or modification, and/or the like of goods and services across international borders, including a host of integrated tools for navigating the complexities of import-export bureaucracies and simplifying the cross border shopping process. A graphical user interface is provided to receive user edits, specifications, modifications, manipulations, comments, and/or the like with respect to products in a product catalog. The editing tools available for a given product may, in one embodiment, be based on manufacturer specifications provided with respect to a given product. The disclosed invention is configurable to facilitate and process transactions at various scales, register and authorize new participants, process product information and provide an online catalog, generate quotes and sales orders, track orders and customer satisfaction, and/or the like.

### PRIORITY CLAIM AND RELATED APPLICATIONS

This disclosure describes inventive aspects of at least four distinct inventions, including:

a transactional facilitation portal (with a suggested Class/Subclass of 705/27);

a transactional parameter selection interface (with a suggested Class/Subclass of 705/411);

a product manipulation and modification interface (with a suggested Class/Subclass of 715/765);

a project and transactional parameter based search engine (with a suggested Class/Subclass of 707/3);

The instant application details claims directed to a product manipulation and modification interface (suggested class/subclass: 715/765). However, in order to develop a reader's understanding of the other invention(s), the descriptions of the invention(s) have been compiled into a single disclosure to illustrate and clarify how aspects of these inventions operate independently, interoperate as between individual inventions, and/or cooperate collectively. The disclosure goes on to further describe the interrelations and synergies as between any of the various inventions within the context of an overarching inventive system; all of which is to further ensure compliance with 35 U.S.C. § 112.

This disclosure claims priority to under 35 U.S.C. § 119 and incorporates by reference U.S. Provisional Patent Applications titled “Apparatuses, Methods and Systems to Effect Cross-Border Payments,” filed Sep. 29, 2006, Ser. No. 60/827,683, Attorney Docket No. 17854-005PV; titled “Apparatuses, Methods and Systems for Market Generation and Matches of Importation and Exportation Transactions,” filed Sep. 29, 2006, Ser. No. 60/827,687, Attorney Docket No. 17854-006PV; titled “Apparatuses, Methods and Systems for a Taxonomy Classifier,” filed Sep. 29, 2006, Ser. No. 60/827,684, Attorney Docket No. 17854-002PV; titled “Apparatuses, Methods and Systems for Market Generation and Matches of Importation and Exportation Transactions,” filed Dec. 18, 2006, Ser. No. 60/870,561, Attorney Docket No. 17854-006PV1; titled “Apparatuses, Methods and Systems for Cross-Border Logistical Fulfillment,” filed Sep. 29, 2006, Ser. No. 60/827,688, Attorney Docket No. 17854-004PV; titled “Apparatuses, Methods and Systems for Cross-Border Acquisition,” filed Sep. 29, 2006, Ser. No. 60/827,686, Attorney Docket No. 17854-003PV; titled “Apparatuses, Methods and Systems for a Trade Business Card,” filed Apr. 23, 2007, Ser. No. 60/913,521, Attorney Docket No. 17854-010PV.

This disclosure is also related to co-pending Patent Cooperation Treaty patent application no. PCT/______ filed Sep. 28, 2007, entitled “APPARATUSES, METHODS AND SYSTEMS FOR CROSS BORDER PROCUREMENT,” attorney docket no. 17894-003PC; Patent Cooperation Treaty patent application no. PCT/______ filed Sep. 28, 2007, entitled “SYSTEMS, METHODS AND APPARATUSES FOR IMPORTATION AND EXPORTATION TRANSACTION LOGISTICS FACILITATION,” attorney docket no. 17894-004PC; Patent Cooperation Treaty patent application no. PCT/______ filed Sep. 28, 2007, entitled “SYSTEMS, METHODS AND APPARATUSES FOR A PAYMENT FACILITATION ENGINE,” attorney docket no. 17894-005PC; Patent Cooperation Treaty patent application no. PCT/______ filed Sep. 28, 2007, entitled “SYSTEMS, METHODS AND APPARATUSES FOR IMPORTATION AND EXPORTATION TRANSACTION FACILITATION,” attorney docket no. 17894-006PC; U.S. non-provisional patent application Ser. No. ______ filed Sep. 28, 2007, entitled “APPARATUSES, METHODS AND SYSTEMS FOR A TRANSACTIONAL FACILITATION PORTAL,” attorney docket no. 17894-003US1; U.S. non-provisional patent application Ser. No. ______ filed Sep. 28, 2007, entitled “APPARATUSES, METHODS AND SYSTEMS FOR A TRANSACTIONAL PARAMETER SELECTION INTERFACE,” attorney docket no. 17894-003US2; U.S. non-provisional patent application Ser. No. ______ filed Sep. 28, 2007, entitled “APPARATUSES, METHODS AND SYSTEMS FOR A PROJECT AND TRANSACTIONAL PARAMETER BASED SEARCH ENGINE,” attorney docket no. 17894-003US4; U.S. non-provisional patent application Ser. No. ______ filed Sep. 28, 2007, entitled “SYSTEMS, METHODS AND APPARATUSES FOR IMPORTATION AND EXPORTATION TRANSACTION LOGISTICS FACILITATION,” attorney docket no. 17894-004US1; U.S. non-provisional patent application Ser. No. ______ filed Sep. 28, 2007, entitled “SYSTEMS, METHODS AND APPARATUSES FOR A PAYMENT FACILITATION ENGINE,” attorney docket no. 17894-005US1; U.S. non-provisional patent application Ser. No. ______ filed Sep. 28, 2007, entitled “SYSTEMS, METHODS AND APPARATUSES FOR IMPORTATION AND EXPORTATION TRANSACTION FACILITATION,” attorney docket no. 17894-006US1; and U.S. non-provisional patent application Ser. No. ______ filed Sep. 28, 2007, entitled “SYSTEMS, METHODS AND APPARATUSES FOR IMPORTATION AND EXPORTATION PROCUREMENT, LOGISTICS, AND PAYMENT TRANSACTION FACILITATION,” attorney docket no. 17894-006US2.

The entire contents of the aforementioned applications are herein expressly incorporated by reference.

### FIELD

The present invention is directed generally to an apparatuses, methods, and systems of commerce, and more particularly, to APPARATUSES, METHODS AND SYSTEMS FOR A PRODUCT MANIPULATION AND MODIFICATION INTERFACE (hereinafter “Procurer”).

### BACKGROUND

Increasingly, shoppers engage online shopping systems to satisfy their purchasing needs, supplanting traditional brick and mortar shopping establishments in the process. Consequently, many established merchants have expended considerable resources and effort to bring their shopping catalogs online and to provide shoppers with the ability to access, browse, search, and order their products from the comfort of their own homes. Additionally, some websites have been created that amalgamate products from different vendors into integrated catalogs within a single online shopping experience. Importing and exporting of products has also been practiced throughout the history of commerce and trade. Often, such cross-border transactions are complicated, involving a variety of entities besides the manufacturer, vendor, and buyer, such as freight carriers, banks, insurers, inspectors, and regulatory agencies.

### SUMMARY

This disclosure details implementations of apparatuses, methods and systems for a product manipulation and modification interface. Existing online shopping systems are largely geared towards small scale purchasing, transactions spanning relatively small regions, transactions within particular industries, and static product specifications that are non-responsive to changing purchaser needs. They fail to provide infrastructure for product identification, categorization, modification, and incorporation into an online shopping experience for products across a broad spectrum of industries that is conducive to larger scale purchasing. The lack of modifiability restricts the use of existing shopping systems for high-volume and/or high-risk purchasing applications, where a purchaser may demand a greater degree of customizability as a premium for patronage. The present invention overcomes these limitations by providing a comprehensive shopping experience configured to manage the complexities of cross border transactions, thereby improving transactional efficiency and providing fresh opportunities for commerce between participants. A graphical user interface is provided to receive user edits, specifications, modifications, manipulations, comments, and/or the like with respect to products in a product catalog. The editing tools available for a given product may, in one embodiment, be based on manufacturer specifications provided with respect to a given product.

In one embodiment, a processor-implemented method to generate a product modification user interface is described, comprising: receiving a user product selection; querying a product profile corresponding to the user product selection; retrieving a set of modifiable product feature identifiers from the product profile; and providing interface elements configured to admit edits to product features corresponding to the set of modifiable product feature identifiers.

### BRIEF DESCRIPTION OF THE DRAWINGS

The accompanying appendices and/or drawings illustrate various non-limiting, example, inventive aspects in accordance with the present disclosure:

FIG. 1 provides an implementation of logic flow showing general process flow in one embodiment of Procurer operation;

FIG. 2 shows an implementation of logic flow for general site navigation in one embodiment of Procurer operation;

FIG. 3 shows an implementation of logic flow for facilitating system transactions in one embodiment of Procurer operation;

FIG. 4 shows an implementation of logic flow for participant registration in one embodiment of Procurer operation;

FIG. 5 shows an overview of an implementation of logic flow for logging into the Procurer system in one embodiment of Procurer operation;

FIGS. 6A-C show product information fields associated with a product managed by the Procurer in embodiments of Procurer operation;

FIG. 7 shows an overview of an implementation of logic flow for generation of a virtual shopping environment in one embodiment of Procurer operation;

FIG. 8 shows an implementation of a user interface for a Procurer main page in one embodiments of Procurer operation;

FIG. 9 shows an implementation of logic flow for product procurement and/or searching in one embodiment of Procurer operation;

FIGS. 10A-B show another implementation of logic flow for product searching in another embodiment of Procurer operation;

FIG. 11 shows an implementation of a Procurer search page, including browsing features, in one embodiment of Procurer operation;

FIG. 12 shows an implementation of an advanced search user interface in another embodiment of Procurer operation;

FIG. 13 shows an implementation of logic flow for providing products associated with a project query in one embodiment of Procurer operation;

FIG. 14 shows an implementation of a pop-up dialog box providing definitions for the guarantee/warranty symbols in one embodiment of Procurer operation;

FIGS. 15A-Q show an implementation of a shopping user interface in one embodiment of Procurer operation;

FIG. 16 shows an implementation of logic flow for product post-selection in one embodiment of Procurer operation;

FIG. 17 shows an implementation of a user interface for generating a good faith estimate quote, requesting a sample, and other product post-selection activities in one embodiment of Procurer operation;

FIG. 18 shows an implementation of logic flow underlying good faith estimate generation in one embodiment of Procurer operation;

FIG. 19 shows an implementation of logic flow for good faith estimation in another embodiment of Procurer operation;

FIG. 20 shows an example of a product markup table in one embodiment of Procurer operation;

FIG. 21 shows an implementation of logic flow for sample request facilitation in one embodiment of Procurer operation;

FIG. 22 shows an implementation of logic flow for generating product quotes in one embodiment of Procurer operation;

FIGS. 23A-B shows aspects of quote and product line sheet generation in particular embodiments of Procurer operation;

FIG. 24 shows an implementation of logic flow for generation of an official quote in another embodiment of Procurer operation;

FIG. 25 shows an implementation of logic flow for quote finalization and order generation in one embodiment of Procurer operation;

FIG. 26 shows an implementation of logic flow for sales order generation in one embodiment of Procurer operation;

FIG. 27 shows an implementation of logic flow for sales order generation in another embodiment of Procurer operation; and

FIG. 28 is of a block diagram illustrating embodiments of the present invention of a Procurer controller;

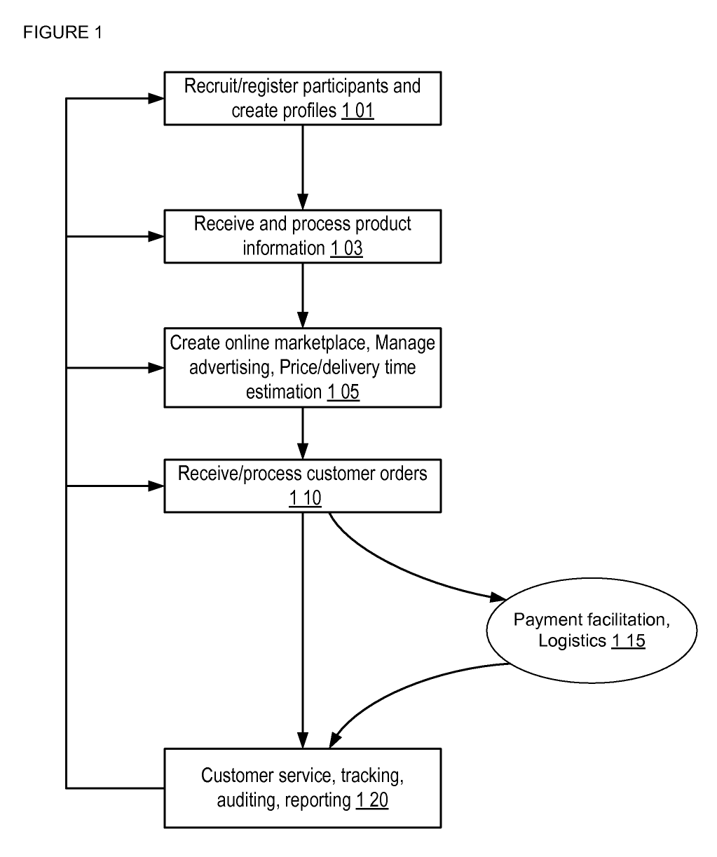

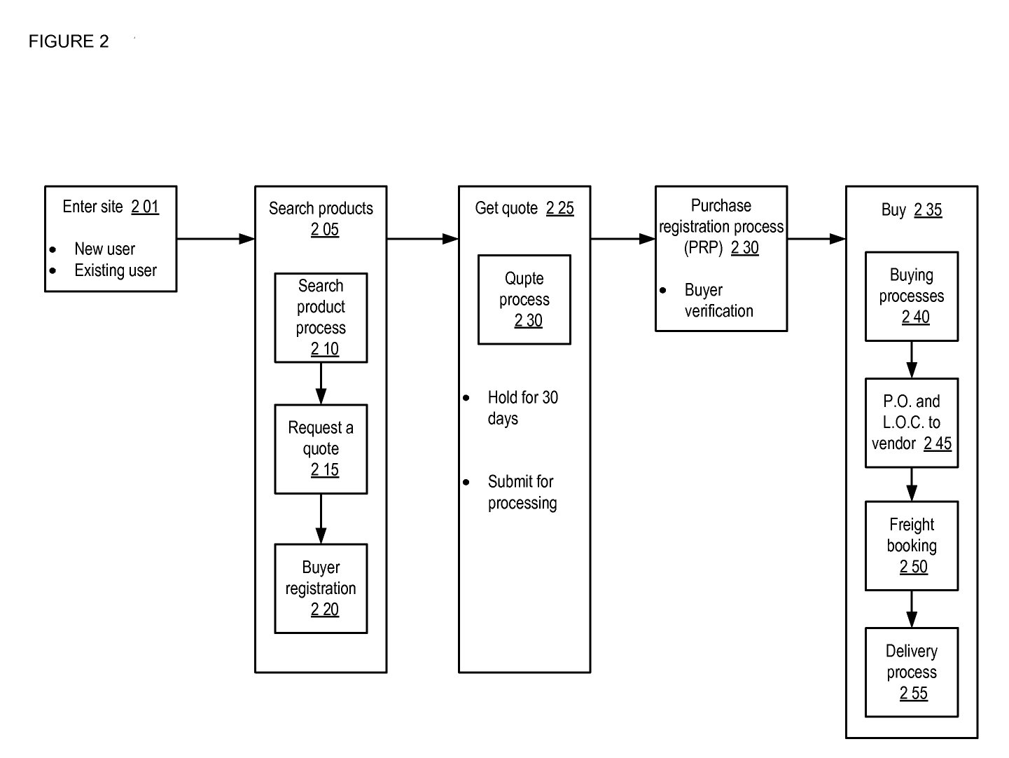

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

In order to address various issues such as those discussed above, the invention is directed to apparatuses, methods, and systems for cross border procurement. It is to be understood that, depending on the particular needs and/or characteristics of any number of participating buyers, sellers, importers, exporters, carriers, payment Procurers, system administrators, and/or the like, various embodiments of the Procurer may be implemented that enable a great deal of flexibility and customization. The instant disclosure discusses an embodiment of the Procurer in the context of coordinating cross border procurement of consumer products. However, it is to be understood that the system described herein may be readily configured and/or customized for a wide range of applications or implementations. For example, aspects of the Procurer system may be adapted for use in procuring a variety of other types of goods and services, arranging labor outsourcing, coordinating supply chain management, and/or the like. It is to be understood that the Procurer may be further adapted to a variety of other commercial and/or operational applications.

### Procurer Overview

The Procurer provides functionalities facilitating online procurement, shopping, transacting, and/or the like of goods and services across international borders. It includes a host of integrated tools for navigating the complexities of import-export bureaucracies and simplifying the cross border shopping process. Existing systems often merely facilitate transactions on a business-to-business level, providing leads for connecting one business to another, but failing to provide a wide scope of transactional opportunities across multiple businesses, locations, markets, and/or the like and often leaving users to handle the intricacies of the import-export process by themselves. The Procurer overcomes these limitations by providing a complete, front-to-end solution for facilitating cross border transactions that operates with full awareness of the import-export process and other complexities that arise within such transactions. The Procurer is also configurable to facilitate and process transactions at various scales, register and authorize new participants, process product information and provide an online catalog, generate quotes and sales orders, track orders and customer satisfaction, and/or the like. These and other Procurer functionalities will become apparent in light of the following figures and description.

FIG. 1 provides an implementation of logic flow showing general process flow in one embodiment of Procurer operation. The Procurer may solicit, recruit, and/or receive new participants who subsequently register with the Procurer in order to create unique profiles 101. Registered participants may supply product and/or transaction logistics information, which is received and processed by the Procurer 103, in order to generate a product database. That database may be drawn upon to create an online catalog or marketplace, to manage product advertising, and to provide estimates of product prices and/or delivery times in conjunction with customer quotes and/or orders 105. Customers who shop the online catalog may submit order requests receivable by the Procurer 110, which processes the order requests to generate sales requests by which the customer orders are memorialized and ultimately fulfilled. The Procurer works with logistical and payment facilitation components to coordinate the transfer of goods and/or services and the effectuation of payment 115. Embodiments of these components are described in greater detail in co-pending application “SYSTEMS, METHODS AND APPARATUSES FOR IMPORTATION AND EXPORTATION TRANSACTION LOGISTICS FACILITATION”, Armand Rousso, filed Sep. 28, 2007, Attorney Docket No. 17854-004PC. The Procurer is further configurable to provide services related to customer service; tracking of orders, customer behavior, seller reputation, payment progress, product and/or advertising success, and/or the like; auditing; and a variety of reporting pertaining to activities facilitated by the Procurer 120.

FIG. 2 shows an implementation of logic flow for general site navigation in one embodiment of Procurer operation. A user enters the site at 201 and, depending on whether it is an existing or a new user, may be granted access to Procurer features and/or requested to register and create a new user profile. The user, seeking to leverage the Procurer to find and/or purchase one or more products and/or services, may perform a search of products 205. In addition to undertaking a search product process 210 to find the desired products and/or services, the user may request a product quote 215 and, if not already registered and/or logged in, undergo a buyer registration process 220. The quote may be subsequently provided to the user 225 after being created by a quote generation process 230. The generated quote may be held as valid for a pre-set period of time (e.g., 30 days) during which it may be acted upon for further order processing. A user wishing to act upon the quote to effectuate an order may undertake a purchase registration process (PRP) 232, which includes steps to supply all information needed to finalize the order, including buyer verification, authorization, and/or authentication information. The user may then be allowed to buy 235 the desired products and/or services, which may entail undertaking one or more buying processes 240, supplying a purchase order and/or a letter of credit to a vendor 245, freight booking 250, delivery process 255, and/or other processes of logistical fulfillment and payment facilitation.

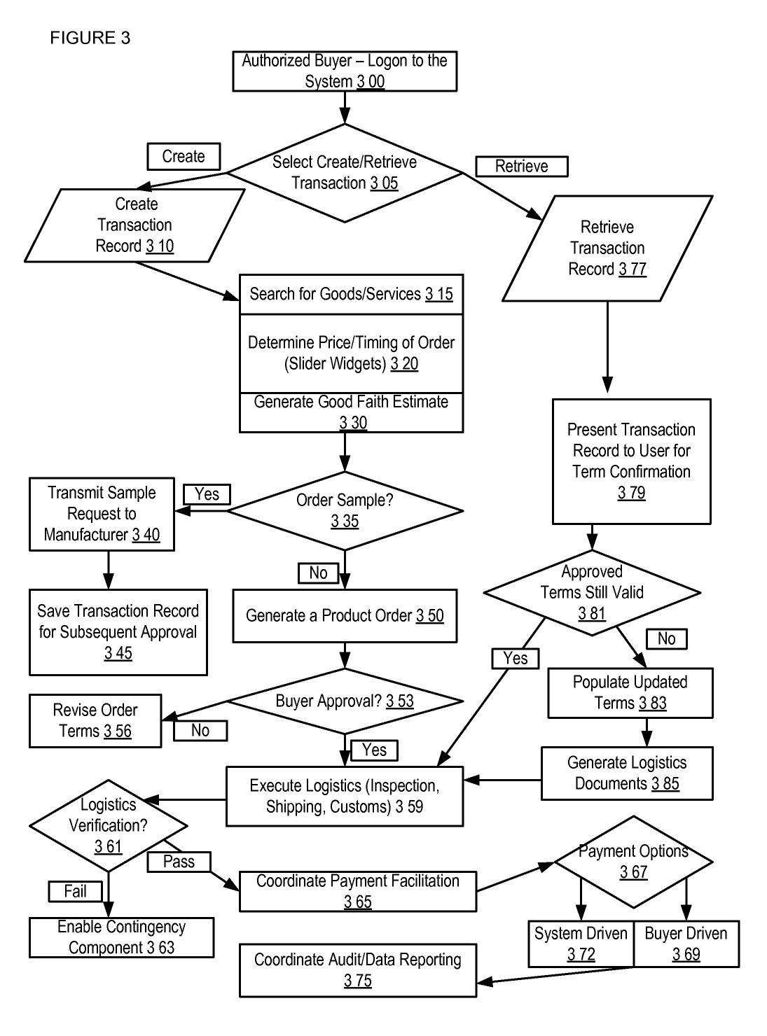

FIG. 3 shows an implementation of logic flow for facilitating system transactions in one embodiment of Procurer operation. An authorized buyer logs in to the system at 300 and decides whether to create a new transaction record or to retrieve an existing one 305. In an alternative implementation, the Procurer may admit purchases by unregistered users. If the user selects to create a new transaction record, then that record is created at 310 by populating a data structure with buyer information as well as information surrounding the current circumstances, such as the date and time, the currently viewed product information, a recently acquired quote, and/or the like. The transaction record may also be configured to record subsequent buyer activity, particularly with regard to product selection, sample ordering, quote generation, product ordering, shipping, tracking, reminders, and/or the like.

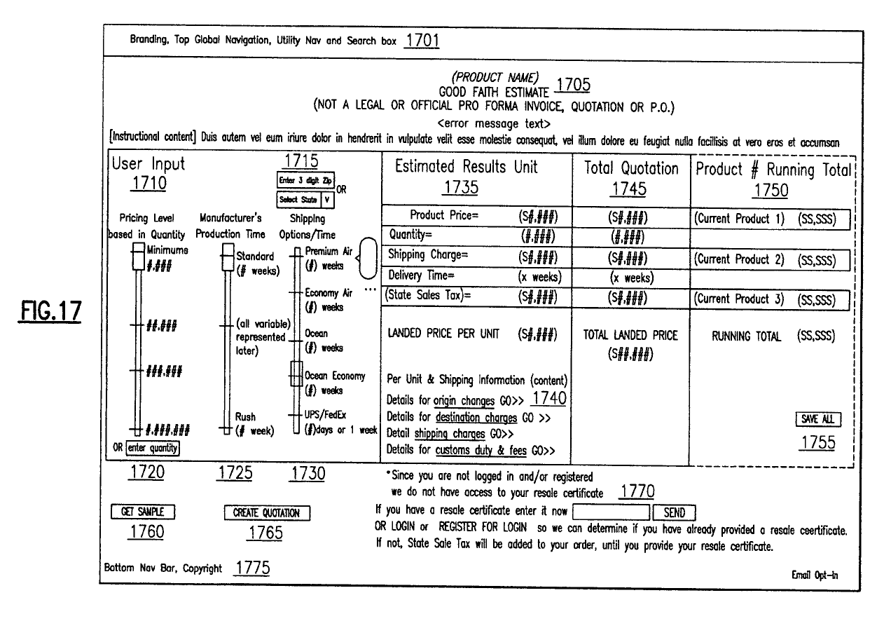

The buyer may then proceed to search for goods and services within the Procurer online catalog of products 315, and may select one or more products of interest therefrom. The buyer may then determine price and/or timing associated with selected products 320 (see, e.g., FIG. 17 below) and request the Procurer to generate a good faith estimate 330, quote, and/or the like. The buyer may then elect to order a sample of a selected product if such a sample is available 335. If the buyer chooses to receive a sample, then a sample request is generated and transmitted to the manufacturer 340, who may subsequently provide the requested sample to the buyer and/or to the Procurer as an intermediary. The sample request and/or additional information pertaining to the product, pricing, shipping, and/or the like may also be stored for future review, approval, ordering, and/or the like 345.

If no sample is required, then a product order is generated at 350, and buyer approval of the order is subsequently sought 353. If the buyer does not approve the order, then the order terms may be revised 356, and/or the buyer may be contacted by a Procurer representative, may be provided with an error message, may be directed to alternative products, and/or the like. If, on the other hand, the buyer approves the order, then the Procurer may proceed to execute the transaction logistics, including aspects such as inspection, shipping, and customs 359.

Returning to 305, a buyer may also elect to retrieve an existing transaction, in which case the Procurer retrieves a selected transaction record 377 and presents the transaction record, including any associated terms and conditions, to the buyer for approval and/or term confirmation 379. Approved terms may then be checked to determine whether a validity condition is satisfied 381. For example, if a specified period of time has transpired since an initial quote with associated terms was provided to the buyer, then a new set of terms may be necessary. In another example, price changes, currency exchange rate variations, shipping rate variations, changes in tariffs, changes in customs regulations, changes in Facilitator administration policies, and/or the like may all contribute to an update requirement for purchase terms and conditions. If an update is required, then updated terms are populated 383. In one implementation, the user may then be provided with an opportunity to approve or reject updated terms. A set of logistics documents may be generated based on the updated terms 385, and the Procurer proceeds to 359 to execute the transactional logistics.

During the course of executing transactional logistics, one or more logistical verification processes may be undertaken 361 to verify the successful unfolding of the transaction. Details of logistical execution and verification are provided in related co-pending application “SYSTEMS, METHODS AND APPARATUSES FOR IMPORTATION AND EXPORTATION TRANSACTION LOGISTICS FACILITATION”, Armand Rousso, filed Sep. 28, 2007, Attorney Docket No. 17854-004PC, which is incorporated in its entirety herein by reference. In the event of a verification failure, a contingency component may be enabled 363 in order to respond and/or attempt to correct the issue causing the verification failure. Otherwise, the Procurer may proceed to coordinate payment facilitation for the transaction 365, details of which are provided in related application “SYSTEMS, METHODS AND APPARATUSES FOR A PAYMENT FACILITATION ENGINE”, Armand Rousso, filed Sep. 28, 2007, Attorney Docket No. 17854-005PC, which is incorporated in its entirety herein by reference. According to the payment facilitation process, the Procurer may provide payment options 367 to the buyer. For example, a buyer driven payment option may be selected 369, whereby the buyer deals directly with a manufacturer, vendor, and/or the like to effectuate payment and/or receipt of ordered products. Alternatively, a system driven payment option may be selected 372, whereby the buyer provides payment to the Procurer, such as via a buyer account, and the Procurer effectuates payment with manufacturers, vendors, and/or the like. Subsequent to successful payment and/or receipt of ordered products, the Procurer may further coordinate post-purchase activities such as auditing, reporting, purchase tracking, marketing, and/or the like 375.

### Participant Registration and Login

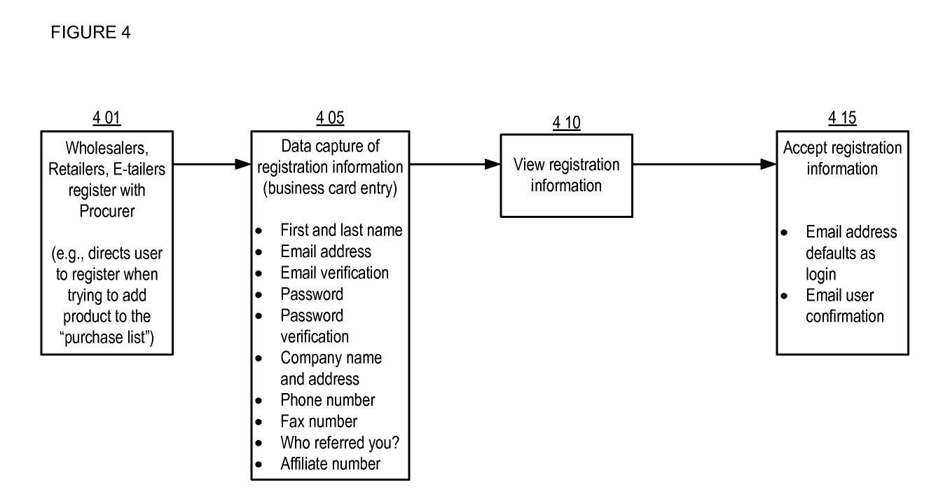

FIG. 4 shows an implementation of logic flow for participant registration in one embodiment of Procurer operation. Various Procurer participants, such as wholesalers, retailers, e-tailers, buyers, distributors, importers, exporters, and/or the like may register with the Procurer 401. Users may be prompted to register at various points of Procurer operation, such as on the homepage, when trying to add a product to the “purchase list”, when trying to upload product information, when trying to receive a quote, and/or the like. The Procurer may perform a data capture of registrant information 405 to build a registrant profile and in some instances a registrant trade business card. The trade business card includes business profile data about a participant and/or his or her that provides other companies and individuals access to view a provider's services, products and other offerings.

In one embodiment, the trade business card travels (i.e., is visible) on every Procurer web page and is automatically populated with required data entry fields from searches through the approved purchase process. Further details surrounding the trade business card are provided in related application entitled “Apparatuses, Methods and Systems for a Trade Business Card,” filed Apr. 23, 2007, Ser. No. 60/913,521, Attorney Docket No. 17854-010PV.

Among the information that a user may be requested to enter are a first and last name, an email address and verification, a password and verification, a company name and address, a phone number, a fax number, category of business, customs category, shipping identification and/or registration information, Dun & Bradstreet information and/or profile, referral information, and/or the like. Once all registration information has been received, the Procurer may, in one implementation, present a formatted user profile for the user to view 410. The user may then be provided with the opportunity to accept, approve, and/or edit the registration information 415.

In one implementation, the user's email address becomes the user login name by default, and a confirmation message is sent to the user's email address as specified in his or her registration information. The confirmation email may require the user to click on a link provided therein in order to verify the validity of the supplied email address. In another implementation, the user may be permitted to upload a trademark, company logo, and/or the like in conjunction with profile and/or product information. In still another implementation, the user may be permitted to specify preferred sellers and/or manufacturers, products, industries, and/or the like.

In one implementation, the Procurer may be configured to admit registration for two levels of access. For example, a buyer may register for level 1 access by submitting information such as: a first name, a last name, a company name, a title, a company street address, a city, a state, a zip code, a company and/or user phone number, an email address, a state resale certificate and/or certificate number, and/or the like. Additional optional fields may be provided for completion, such as opt-in alerts for mobile alerts, email alerts, webcasts, podcasts, and/or the like, as well as a company's industry, types of products in which the user is interested, self-describing keywords, and/or the like.

To register for level 2 access, the user may be requested to enter level 1 registration information as well as additional information such as: a company's main phone number; a company facsimile number; additional company addresses and/or shipping addresses; additional billing addresses; an authorizing company official's name, title, phone number, email, and/or other contact information; a company federal ID number; a buyer's bank name, address, city, state, contact name, telephone number, and/or the like; optional information, such as whom may be contacted for buyer verification, how agents and/or buying groups may be authorized, and/or the like. In one implementation, a user may not be granted level 2 access until the Procurer administers a buyer credit check, background check, phone call to an authorized company official, and/or the like.

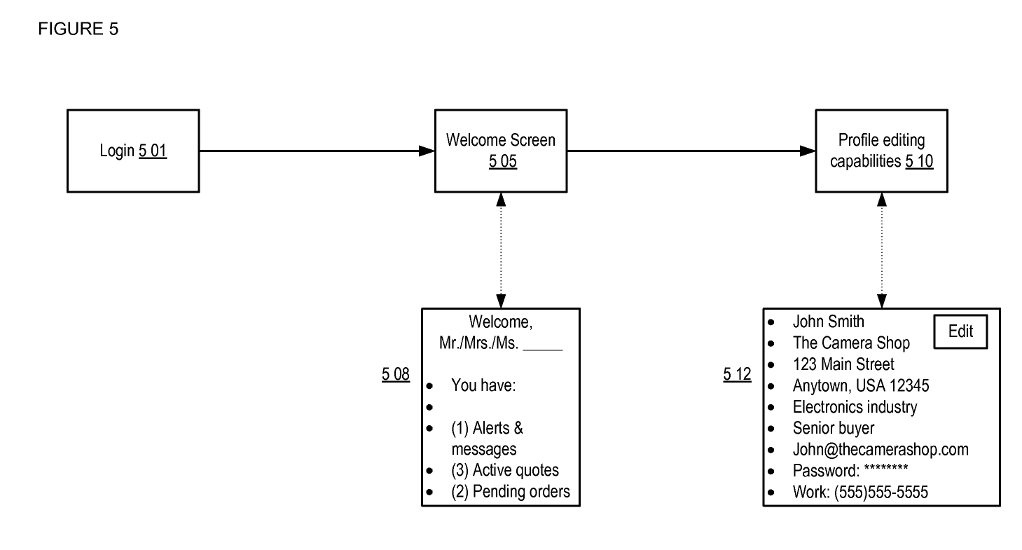

FIG. 5 shows an overview of an implementation of logic flow for logging into the Procurer system in one embodiment of Procurer operation. A user enters login information at 501 to gain access to the Procurer site. He or she is subsequently provided with a welcome screen 505, a schematic example of which is provided at 508. The example includes links to alerts and messages, active quotes, and pending orders. The user may also be provided with a link to his or her profile, for viewing or editing 510. A schematic example of a subset of user profile information is provided at 512, and includes user information such as name, company name, physical address, industry category, job title and/or position, email address, password, phone number, and/or the like.

### Building the Product Catalog

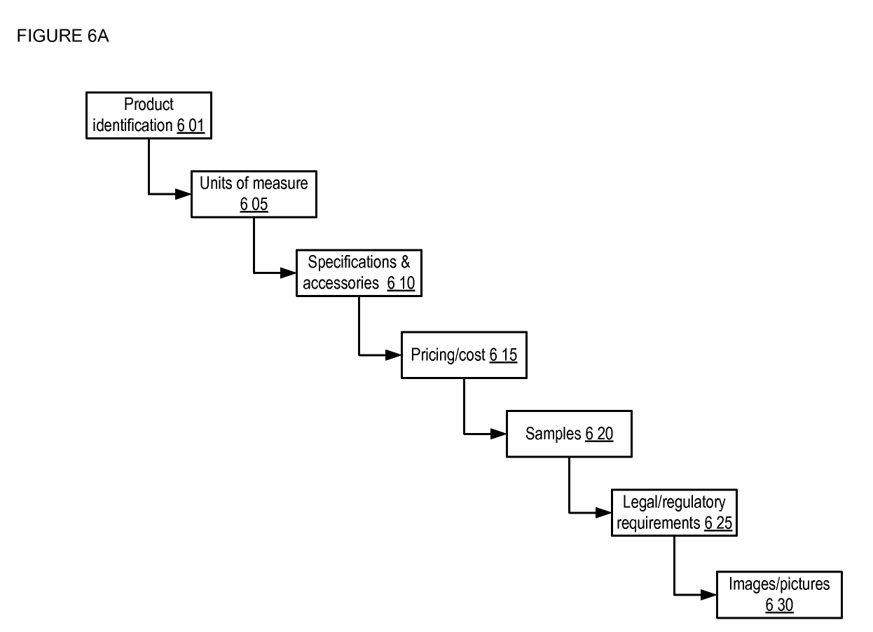

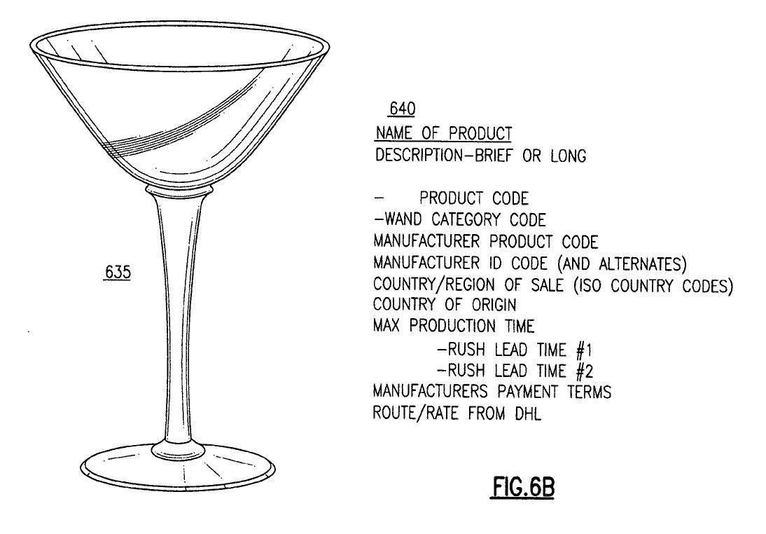

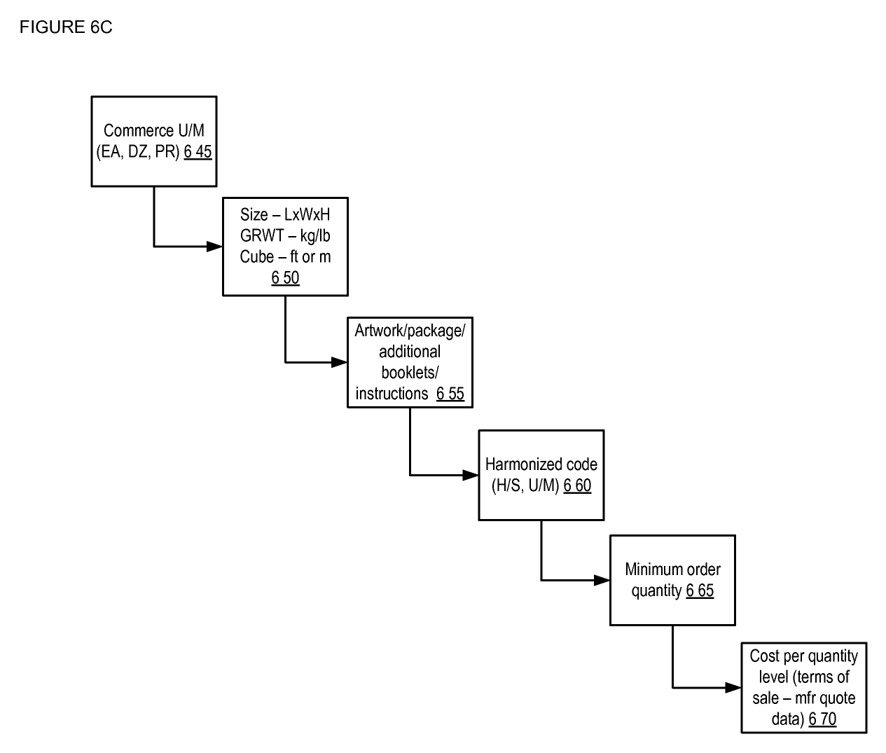

FIG. 6A shows a listing of product information fields associated with a product managed by the Procurer in one embodiment of Procurer operation. The fields listed include: a product identification 601, such as a brand and/or product name, SKU and/or UPC number, barcode image, manufacturer code, retailer code, and/or the like; units of measure 605, such as weight units, volume units, number units, and/or the like; specifications and accessories 610, such as a product description, summary of product specifications, minimum order requirements, country of origin, manufacturer information, production time, warranties, guarantees, allowed shipping methods, freight information, special handling instructions (e.g., perishable, fragile, toxic, flammable, etc.), and/or the like; pricing and/or cost information 615, such as price per unit, discounts, special handling premiums, characteristic fees, and/or the like; samples information 620, describing availability and/or characteristics of product samples; legal and/or regulatory requirements 625, such as purchase terms and/or conditions, import and/or export restrictions, resale regulations and/or agreement terms, and/or the like; and product images, drawings, and/or pictures 630.

In one implementation, a Procurer user (e.g., a product manufacturer) may be required to submit some or all of these fields, such as via an Excel spreadsheet and/or the like, in order to register a product with the Procurer to be included within a virtual shopping environment. In another implementation, a Procurer user may submit a subset of required product information and save the submission for subsequent augmentation and/or editing. In one implementation, submitted product information may be analyzed, either automatically or by a Procurer administrator, in order to ensure compliance with Procurer product information requirements.

FIG. 6B shows another implementation of product information as may be provided to the Procurer by a manufacturer. The product information includes a product image 635 as well as additional product information 640, such as but not limited to: a product name, description, Procurer product code, category code, manufacturer product code and/or other identification codes, country and/or region of sale, country of origin, production time information, manufacturer payment terms, shipping routes and/or rates, and/or the like.

FIG. 6C shows another implementation of additional product information that may be provided by a manufacturer with respect to a given product. The information includes a commerce unit of measure (e.g., each, dozen, pair, and/or the like) 645; product size, gross weight, volume, and/or the like 650; associated artwork, packaging, additional booklets and/or instructions, and/or the like 655; harmonized code 660 (or other tariff classification, customs data); a minimum order quantity, and/or other order quantity limits 665; cost per quantity level, terms of sale, manufacturer quote data, and/or the like 670; or any other number of product procurement, logistics, or payment related parameters.

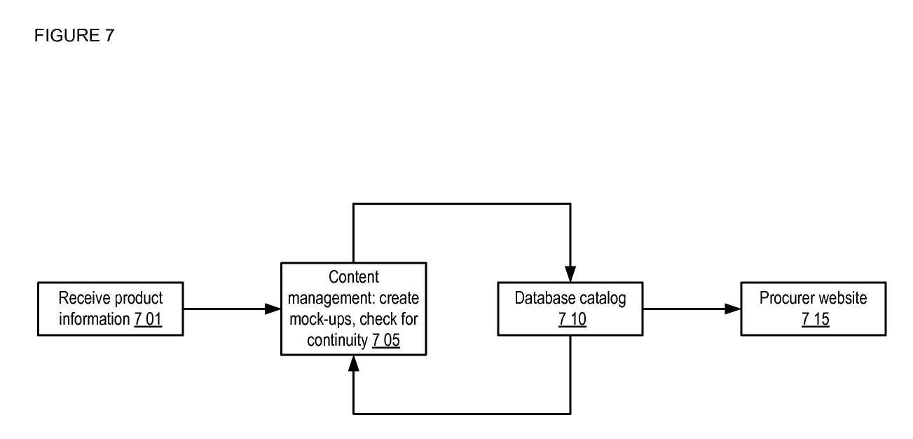

FIG. 7 shows an overview of an implementation of logic flow for generation of a virtual shopping environment in one embodiment of Procurer operation. Product information, such as that detailed in FIG. 6, is received at 701, such as from a manufacturer, retailer, distributor, importer/exporter, and/or the like. The received product information is parsed and analyzed at 705 by one or more content management modules. Such modules may, in one implementation, parse and identify submitted information and/or compare submitted information to existing product information in a product database catalog 710 in order to discern and/or establish product associations.

For example, a product with a given manufacturer association may be associated with and/or otherwise connected to other products having the same manufacturer association. In another implementation, the connections discerned and/or established by content management modules may be employed to place new products and/or product information within the organizational structure of existing products, product information, a product database catalog, and/or the like. In yet another implementation, content management modules may generate a mock-up of a product database catalog entry and/or a catalog entry suitable for display within a virtual shopping environment. Such mock-ups may be provided for display for approval from a product information submitting Procurer user and/or from a Procurer administrator.

In still another implementation, content management modules may be configured to detect overlaps in product information and warn a Procurer user if particular product information is too close to existing product information. In such a case, the user may be prompted to enter additional product information in order to distinguish the new product from the existing product information. In yet another implementation, content management modules may be configured with translation capabilities to convert input product data into a variety of different languages and incorporate them into product attributes display pages directed to different users and/or countries. A user location and/or preferred language may be queried from a user profile in order to the language in which a product catalog should be provided. Once the new product information has been analyzed and appropriately incorporated into the product database catalog, a catalog entry and/or product attributes display associated with the product may be generated and/or incorporated into an area of the Procurer website 715, such as within a virtual shopping environment therein.

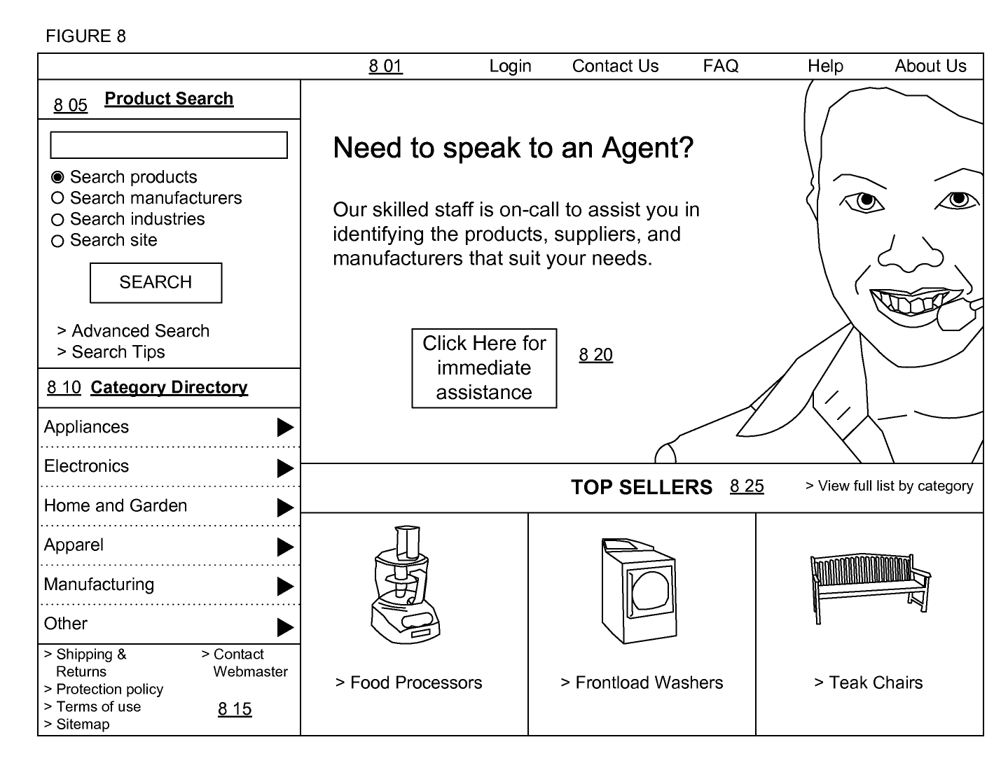

FIG. 8 shows an implementation of a user interface for a Procurer main page in one embodiments of Procurer operation. The page includes a menu bar at the top 801, containing clickable menu options to allow a user to log in, view contact information and/or be provided fields for submitting communications to Procurer administrators, view a list of frequently asked questions with associated answers, engage Procurer help functions, and/or find out more information about the Procurer. The page further includes a product search area 805, whereby a user may search products with information stored in the product database catalog. This area includes a field for entering search terms, and a set of search types configured as radio button options whereby a user may specify a search of products, manufacturers/vendors, industries, the Procurer website, and/or the like. The search area further includes links to advanced search features (discussed below) and search tips.

Below the search field is shown a category directory area 810, wherein a user may browse products by clicking on category names leading to successively more specific product categories and associated product listings. At 815, there is a window with assorted links to various site features and information, including shipping and returns information, protection policy, terms of use, a sitemap, and a link to contact the webmaster. The window at 820 provides a link whereby a user may connect with a Procurer agent for assistance with use of the Procurer website or any number of Procurer features and functionalities. Finally, the page may include advertisements or displays of top selling items 825, such as the food processors, frontload washers, and teak chairs displayed in FIG. 8.

### Searching and Browsing

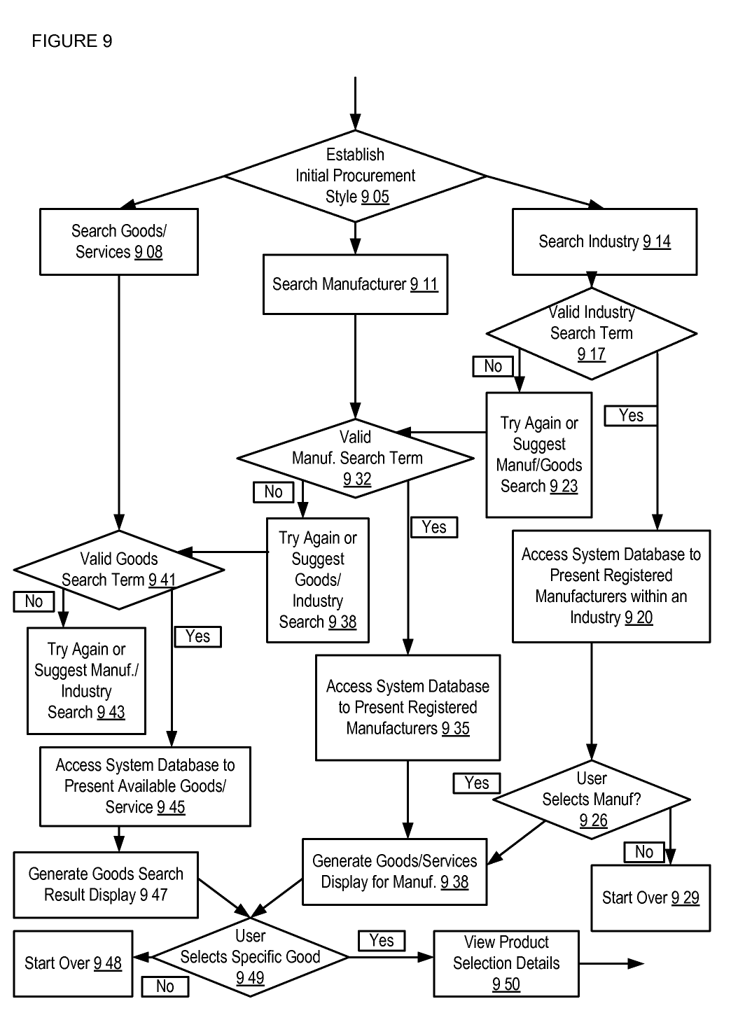

FIG. 9 shows an implementation of logic flow for product procurement and/or searching in one embodiment of Procurer operation. A user may set an initial style for procurement and/or searching of products 905, which may include options such as, but not limited to: searching goods and/or services 908 via names, keywords, categories, and/or the like; searching manufacturer names, types, groups, associations, and/or the like 911; searching industry names, groups, associations, types, categories, and/or the like 914; and/or the like. In the implementation shown, each procurement style selection is followed by a determination as to whether the search term entered comprises a valid industry 917, manufacturer 932, or goods 941 search term. Determination of the validity of a search term may be accomplished, for example, by comparing the term to a list of acceptable search terms, by determining whether the search term yields any matching results, and/or the like.

In FIG. 9, an invalid industry search term may cause the Procurer to prompt the user to try again or to suggest a manufacturer and/or goods and services search 923. Similarly, an invalid manufacturer search term may cause the Procurer to prompt the user to try again or to suggest a goods and services and/or industry search 938. Finally, an invalid goods and services search term may cause the procurer to prompt the user to try again or to suggest a manufacturer and/or industry search 943. A valid industry search term may cause the Procurer to access a system database and retrieve for display one or more matching manufacturers registered with the Procurer system that correspond to the entered industry search term 920.

A user may be provided with the opportunity to select a manufacturer from among those displayed 926 and, if no manufacturer is selected, the user may be returned to a search interface to try another search 929. Otherwise, a display of goods and/or services corresponding to the selected manufacturer is provided at 938. Entry of a valid manufacturer search term may cause the Procurer to access a system database to retrieve one or more registered manufacturer names corresponding to the manufacturer search terms 935, and a goods and/or services display may also be generated for one or more of the retrieved manufacturers 938. A valid goods and services search term may cause the Procurer to access a system database to retrieve one or more goods and/or services records matching the entered search terms 945 and generate a goods and services results display 947 showcasing those results. From either goods and services results display 938 or 947, the user may select one or more goods and services 949. If none is selected, the user may start over and/or perform additional searches 948. Otherwise, the user is provided with product selection details to view 950, and may proceed with additional options and/or Procurer features with respect to the selected products.

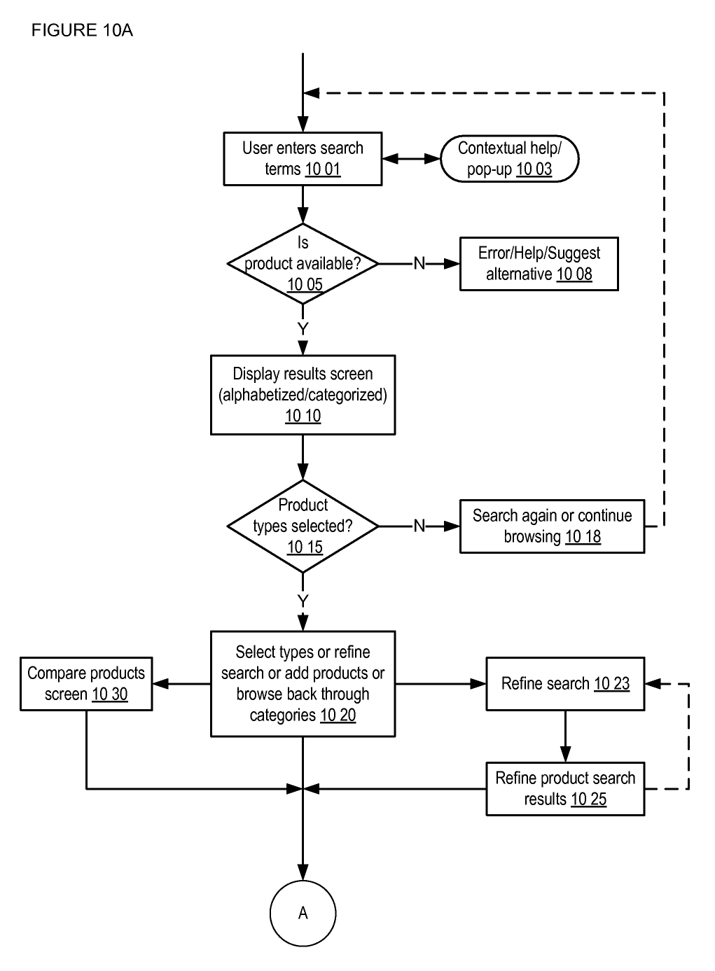

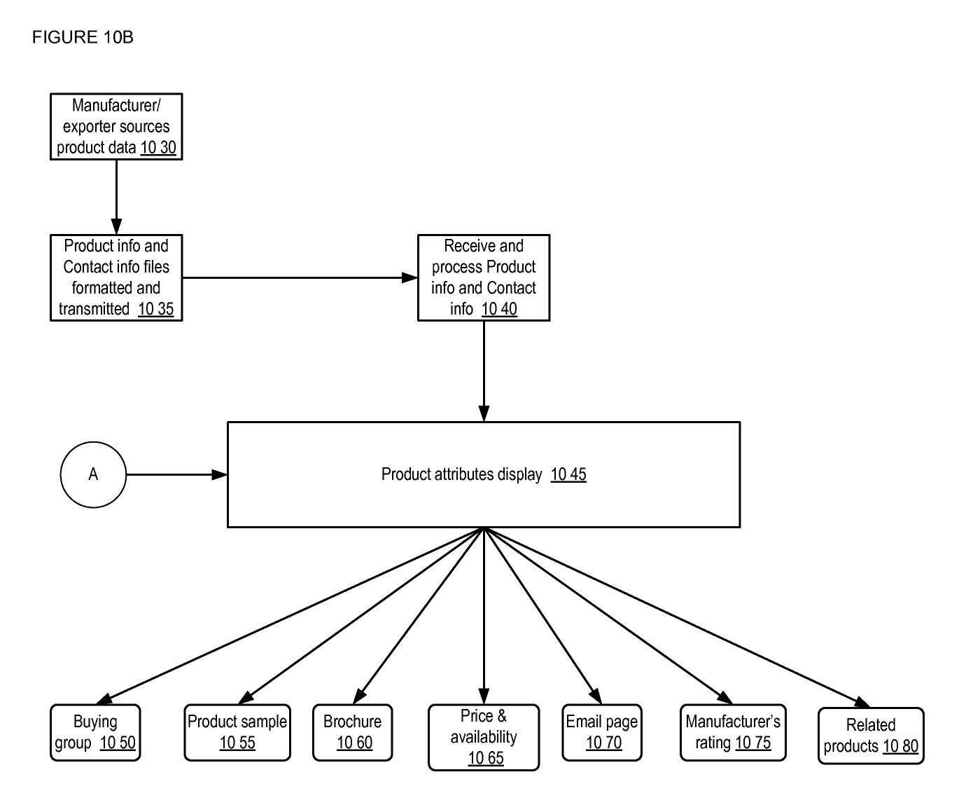

FIGS. 10A-B show another implementation of logic flow for product searching in another embodiment of Procurer operation. A user enters search terms at 1001, at which time he or she may or may not receive contextual help, pop-ups, and/or the like 1003 based on the specific query. The Procurer may, for example, compare the search terms to a collection of known terms that have pre-determined associated actions. A determination is made at 1005 as to whether there are products available matching the user's query. If not, then an error or help message may be supplied, or the Procurer may suggest alternatives to the user 1008. Selection of alternatives may be made, for example, by comparing a user's search terms with a collection of terms having associated terms, products, product categories, and/or the like that correspond to existing products in the Procurer catalog.

If products matching the user search terms are available, these are displayed at 1010, and may be sorted or ordered in a variety of different ways (e.g., alphabetical, categorical, by relevance, by match percentage, etc.). At 1015, a determination is made as to whether the user has selected a subset of products from among those displayed. If not, then the user may continue browsing listed products or conduct another search 1018. Otherwise, if one or more products have been selected, then the user may continue to browse, select specific product types and/or refine the search among the selected products, compare selected products, browse through categories related to selected products, and/or the like 1020. From here, depending on the desired user action, the user may be taken to a compare product screen, wherein characteristics of selected products are shown together to promote easy comparison 1030, or to a refine search screen 1023, where the user may enter additional search terms, select product types and/or categories, specify further desired product characteristics, and/or the like in order to a refined list of product search results 1025.

Once a user has selected a subset of desired products, the flow proceeds to FIG. 10B, wherein the user is presented with product characteristics and interacts with Procurer features and functionalities to acquire further information, samples, make purchases, and/or the like. At 1030, a manufacturer, vendor, and/or other product originator sources product data, such as that described previously, and any contact information or identifying information necessary for a buyer to enable a buyer to successfully consummate a transaction. The collected information is subsequently formatted and transmitted to the Procurer 1035. Such preliminary formatting may, for example, be accomplished by providing a form, electronic or otherwise, for product information to be entered into. In another implementation, product information is formatted by the Procurer after receipt.

At 1040, the product information is received by the Procurer and any remaining processing is applied to put the information in proper condition for inclusion in the Procurer's product catalog database and online shopping experience. The product information corresponding to a given product is packaged as a product attributes display page 1045, which may be presented to a user in response to a search query following the logic flow of FIG. 10A.

Once the user has found a desired product or set of products and is viewing a corresponding product attributes display, he or she may have a variety of options for further action, including but not limited to: creating and/or joining a buying group 1050, such as may be associated with the particular product, a related set of products, other buyers near the user, buyers purchasing products from an area near the user's product, and/or the like; ordering a product sample 1055, if one is available; requesting a product brochure 1060, and/or other product documentation, specification, or other information supplemental to that provided in the products attribute display; price, availability, shipping information, arrival times, quotes, and/or the like 1065; receiving an email of the product attributes display page and/or the product information 1070; querying rating information for the product, manufacturer, and/or the like 1075; receiving a listing of products related to the selected products, such as those that are similar and/or those that are complementary 1080; and/or the like.

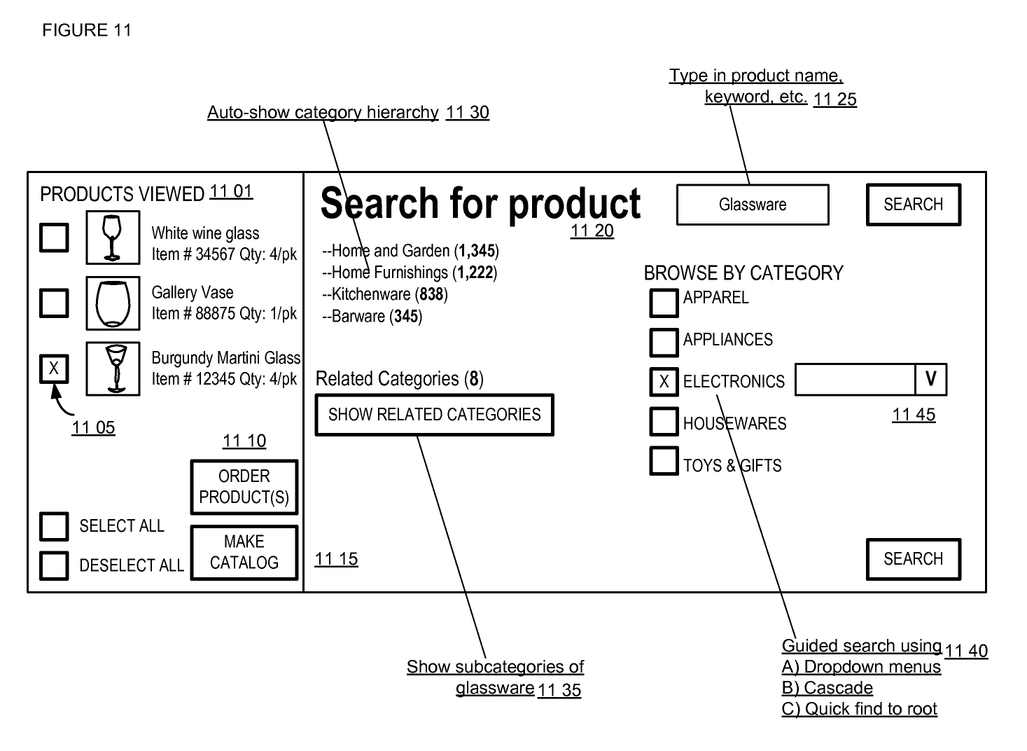

FIG. 11 shows an implementation of a Procurer search page, including browsing features, in one embodiment of Procurer operation. The page includes an area displaying some product information for products viewed by a user 1101. Next to each product in this area is a checkbox 1105, by which a user can select the product to perform actions on thereon, such as ordering the product 1110 or adding the product to a custom catalog 1115 for future review. The page also includes a search area 1120 containing a variety of different search fields and functions.

A user entering search terms in a search field 1125 may trigger the Procurer to produce a listing of categories and/or a category hierarchy 1130 corresponding to the search terms in order to further assist the user with searching and browsing. The page also includes a button 1135 that the user may manipulate to generate a listing of additional categories that are related to the product search terms, though perhaps not as directly as those shown at 1130. Finally, the search area includes a set of options 1140 to allow the user to browse by category and/or refine his or her search based on category designations. For example, a user searching for a washing machine may receive results from both the Appliances category and the Toys & Gifts category (e.g., a toy washing machine for a doll house). By selecting one or the other of these categories, the user may restrict the returned results to the desired class of products. When a category is selected, a drop-down menu 1145 may appear to allow the user to further refine the search results within sub-categories of the selected category.

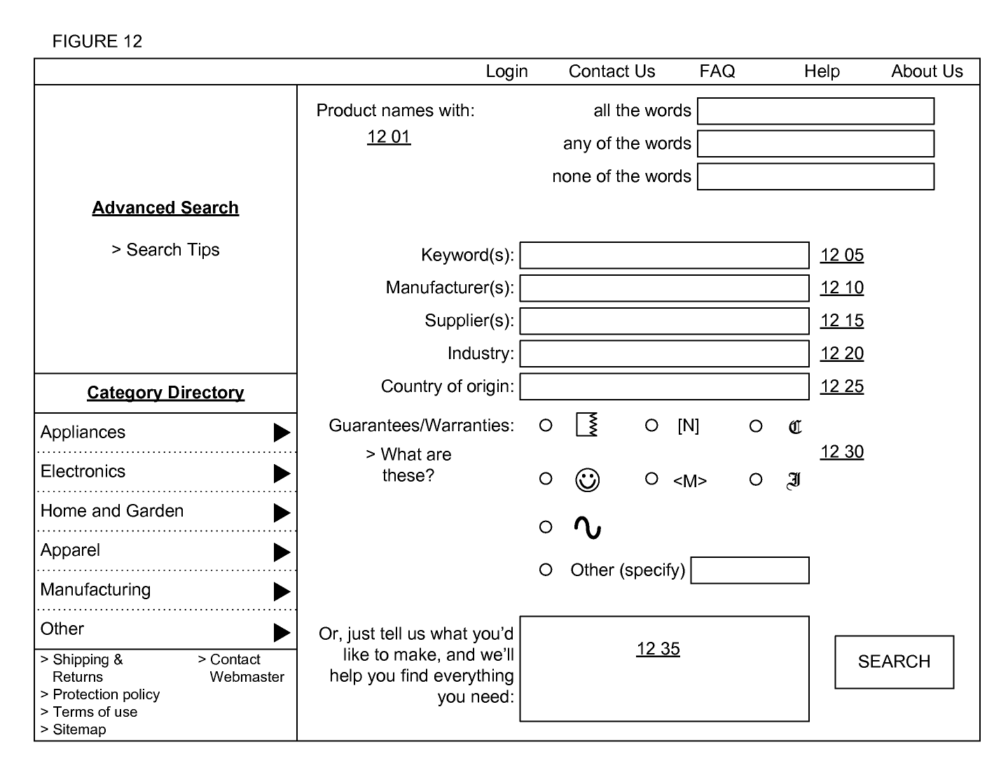

FIG. 12 shows an implementation of an advanced search user interface in another embodiment of Procurer operation. The advanced search interface includes a variety of fields and features that enable search functions that may not be available in the simpler search interface provided at 805 in FIG. 8. The displayed implementation includes fields to enter search terms with different logical interrelationships 1201, including a conjunctive field (“all the words”), a disjunctive field (“any of the words”), a negation field (“none of the words”), and/or the like. Below these are a collection of other fields to enable various types of advanced searches.

These fields include: a keywords field 1205 for entering keywords related to and/or descriptive of a product, product listing, vendor, manufacturer, and/or the like; a manufacturer field 1210 for entering a manufacturer name and/or other manufacturer characteristics; a supplier field 1215 for entering a supplier and/or vendor name, and/or other supplier characteristics; an industry field 1220 for entering an industry name and/or other industry characteristics; a country of origin field 1225 to provide a geographic specification for the country of origin of a set of products; and/or the like. There is also provided a radio button menu of items pertaining to guarantees and/or warranties 1230 that are selectable by a user to filter search results. These are described in greater detail below for the displayed implementation. Finally, there is provided a field at 1235 wherein a user may enter terms describing a project for which multiple products are needed in order to have the Procurer determine those products and provide a corresponding product listing for display.

For example, a user may want to build a silverware set for sale in the United States. He or she may enter such information into the field at 1235, and the Procurer may recognize the project and return products such as knives, dinner forks, salad forks, soup spoons, dessert spoons, butter knives, packaging, labels, and/or the like. Any or all of the search fields described above may be configured to admit either formal or natural language search queries.

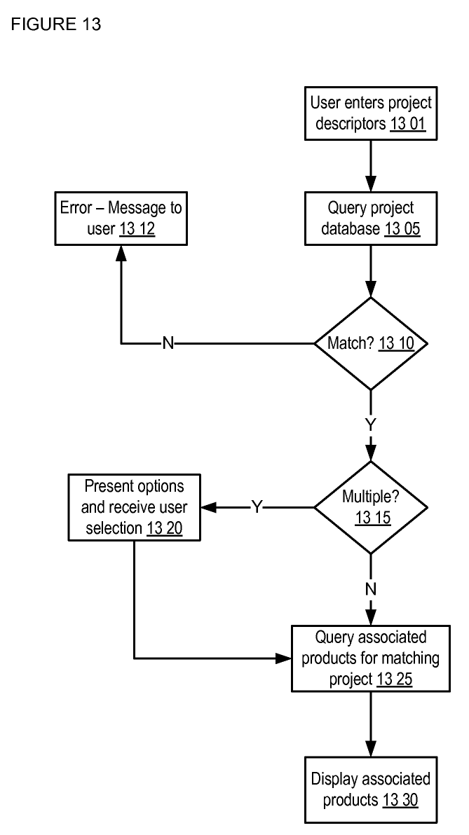

FIG. 13 shows an implementation of logic flow for providing products associated with a project query in one embodiment of Procurer operation. A user enters project descriptors at 1301, such as keywords, formal terms with Boolean connectors, natural language, and/or the like. The descriptors are parsed by the Procurer and used to query a project database 1305, and a determination is made as to whether there are any entries in the database that match the user's query 1310. If not, then an error message may be returned to the user 1312, possibly suggesting an alternative query and/or providing a list of possible near-matches from which the user may make a selection. If a match is found at 1310, then a second determination is made at 1315 as to whether there are multiple matches. If so, then a listing of the matching projects may be presented to the user in order to allow him or her to select therefrom before proceeding further. Once a particular project has been uniquely identified, the Procurer may query a set of products associated with that project within the project database 1325. In one implementation, each project will have an associated set of product query terms associated therewith and, once a project is selected, these product query terms will be used to seed a product search, the results of which are presented to the user 1330.

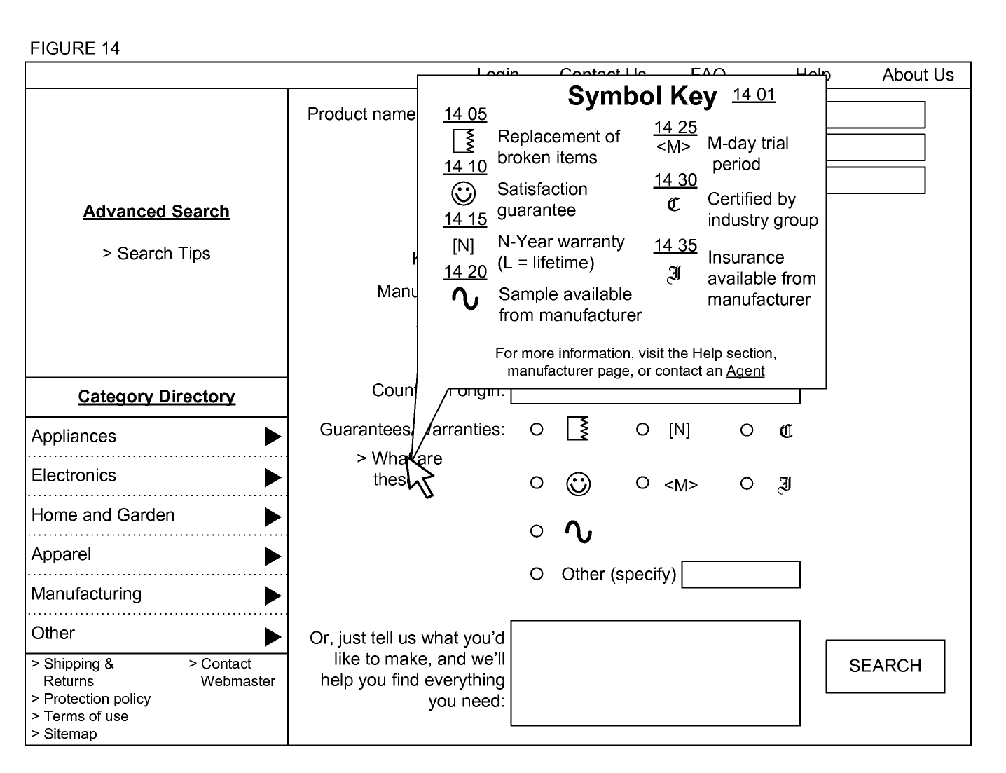

FIG. 14 shows an implementation of a pop-up dialog box providing definitions for the guarantee/warranty symbols in one embodiment of Procurer operation. These symbols provide customers with a quick and convenient visualization of guarantees, warranties, sample availability, trial period availability, insurance, and/or the like associated with products displayed in the Procurer product catalog. For applications of the Procurer that are related to large-scale trade and/or trade across international borders, such a system of symbology may prove to be particularly useful in expressing the often complex terms, conditions, regulations, guarantees, warranties, and/or the like that accompany such transactions. The symbols may represent a wide variety of product characteristics, such as but not limited to: guarantee to replace broken items 1405; satisfaction guarantee 1410; a warranty for N years, or a lifetime warranty 1415; availability of a sample; availability of an M day trial period; industry group certifications 1430; manufacturer or vendor originated insurance 1435; and/or the like. There may also be other pop-up windows and/or other help features employed within the Procurer interface, some of which are described below.

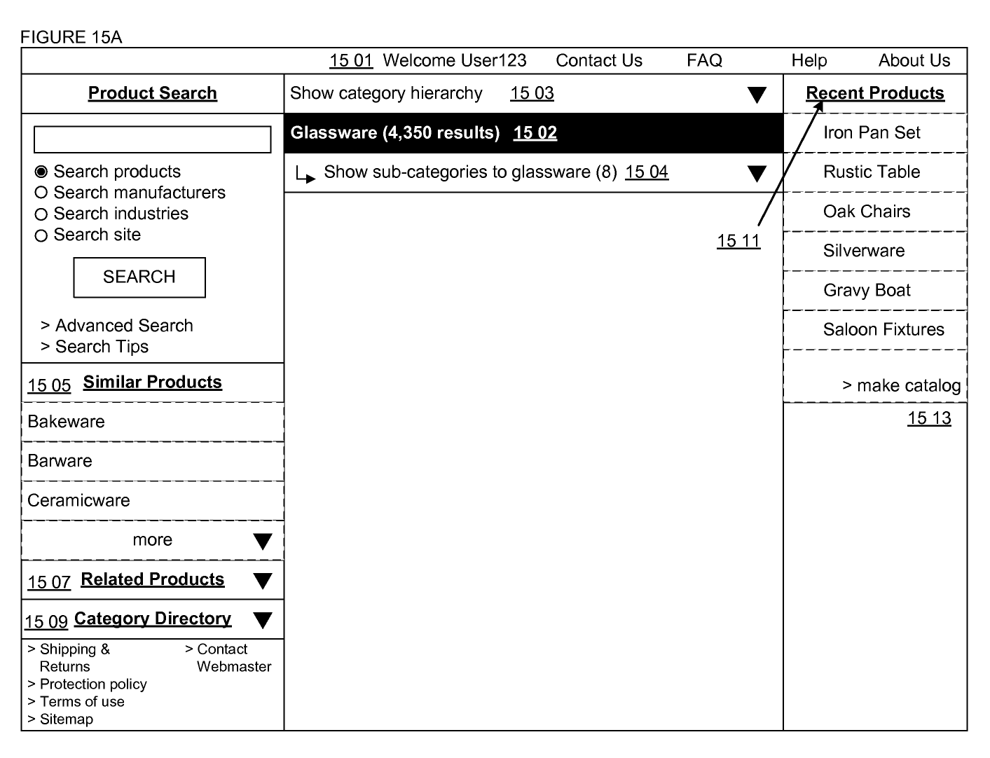

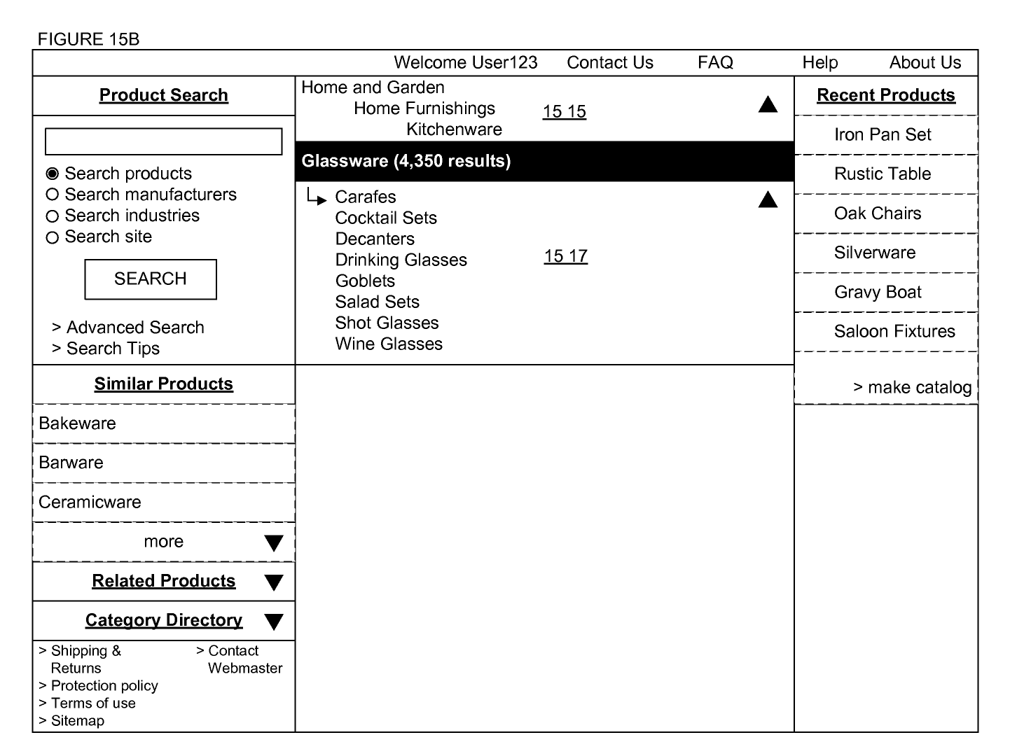

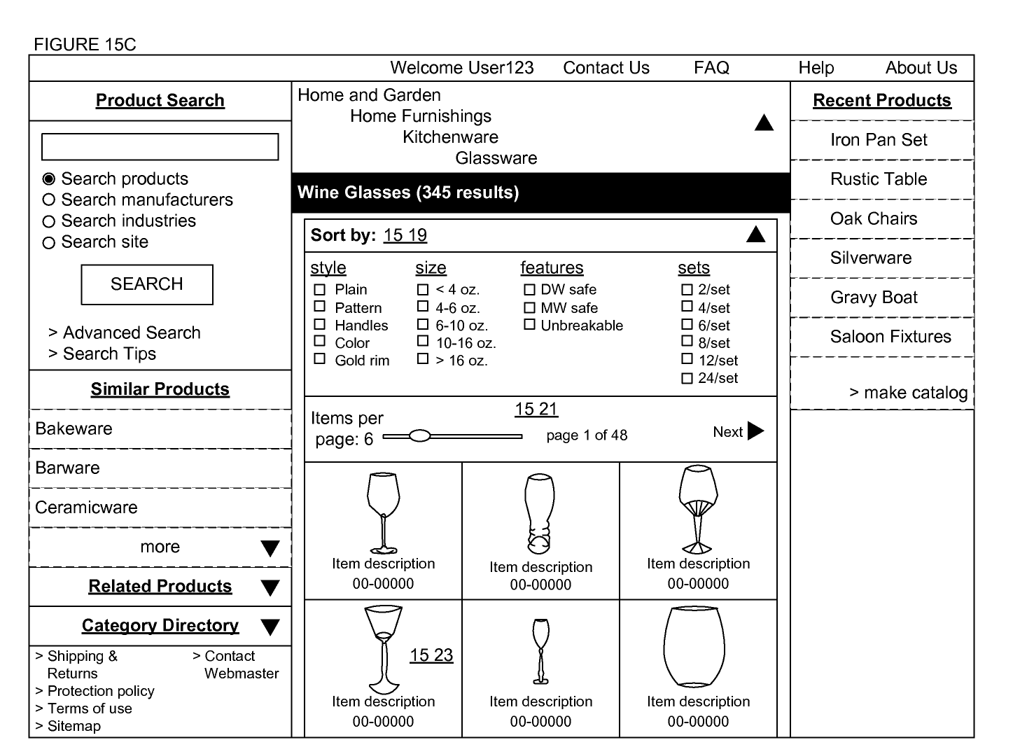

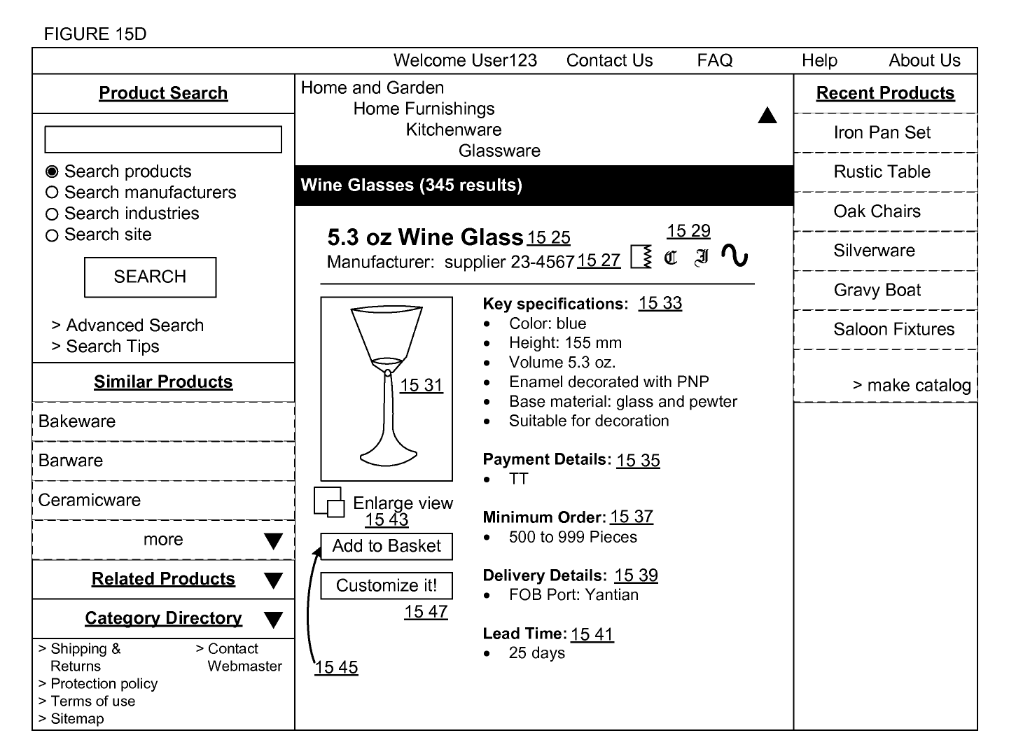

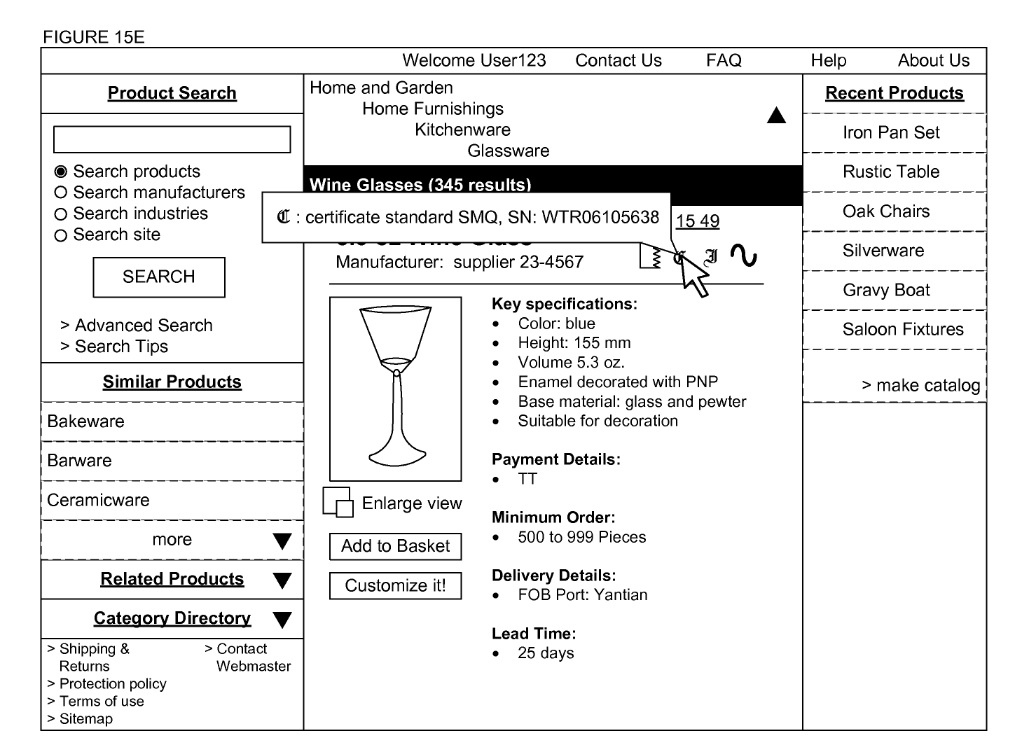

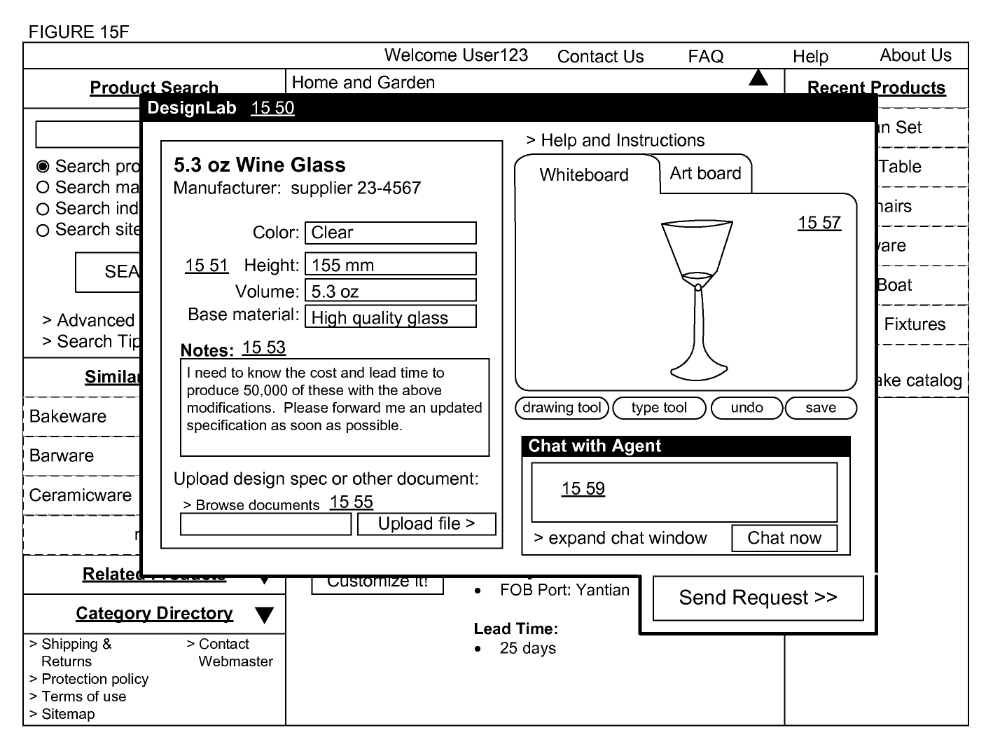

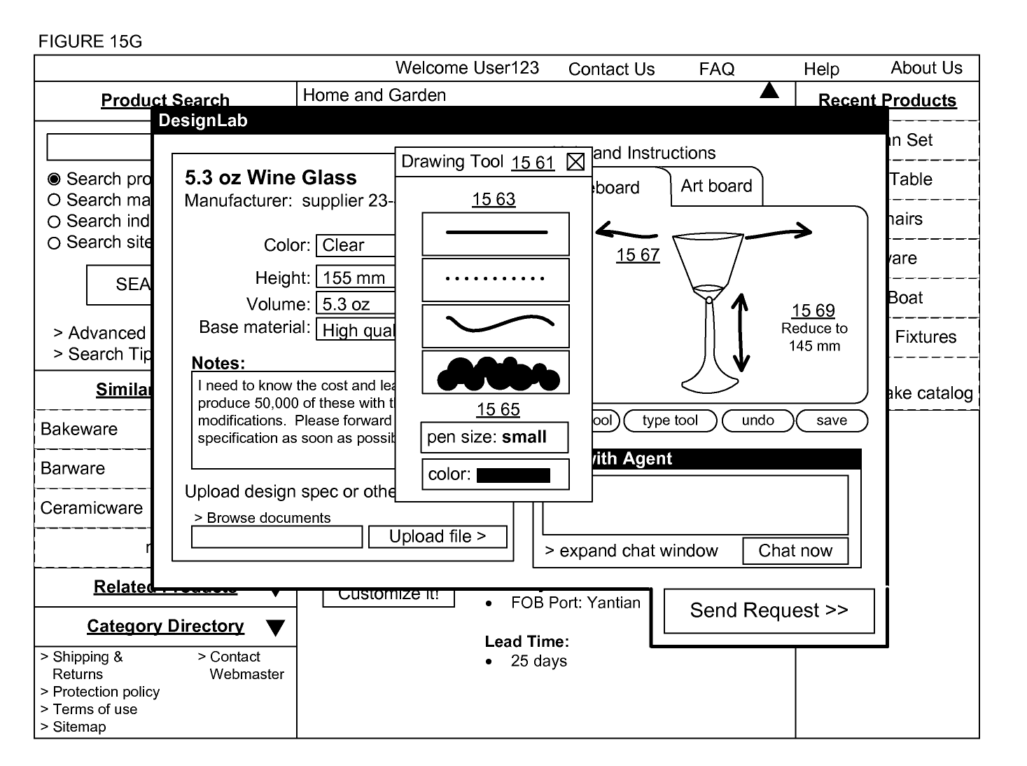

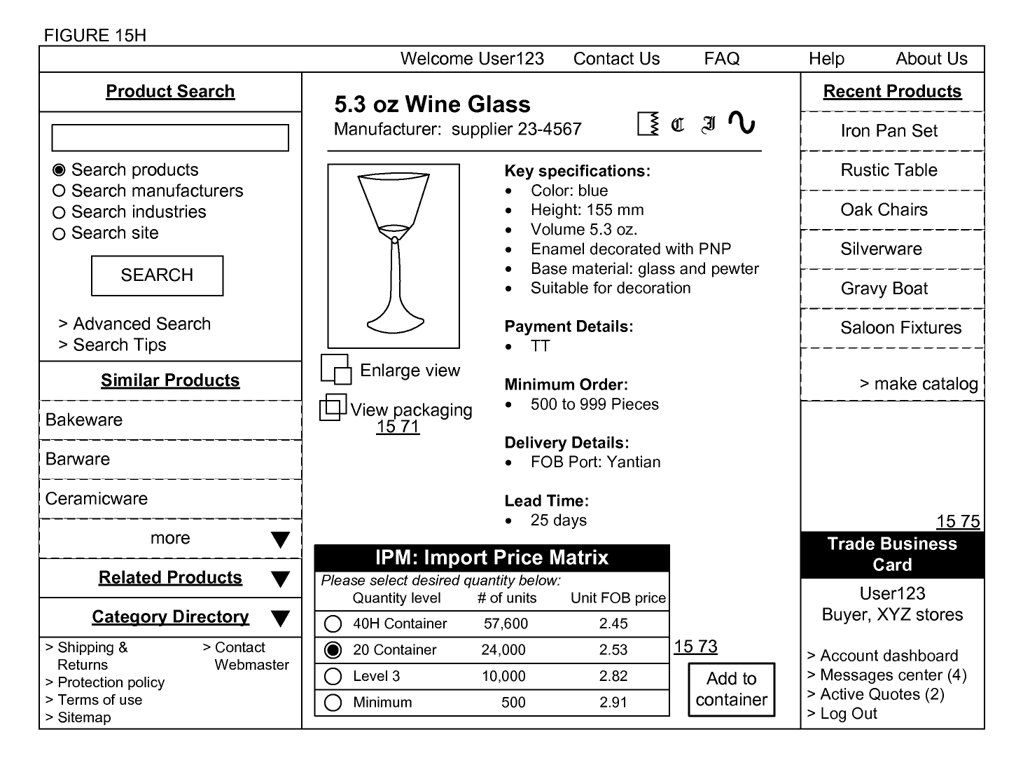

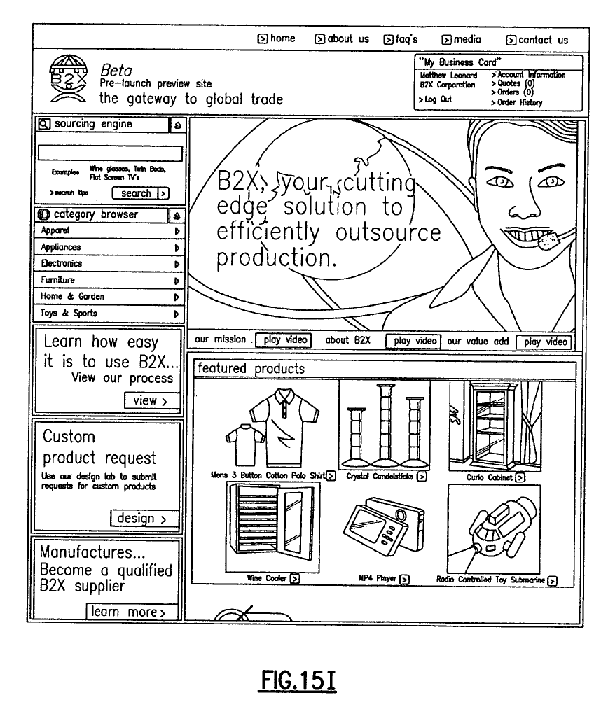

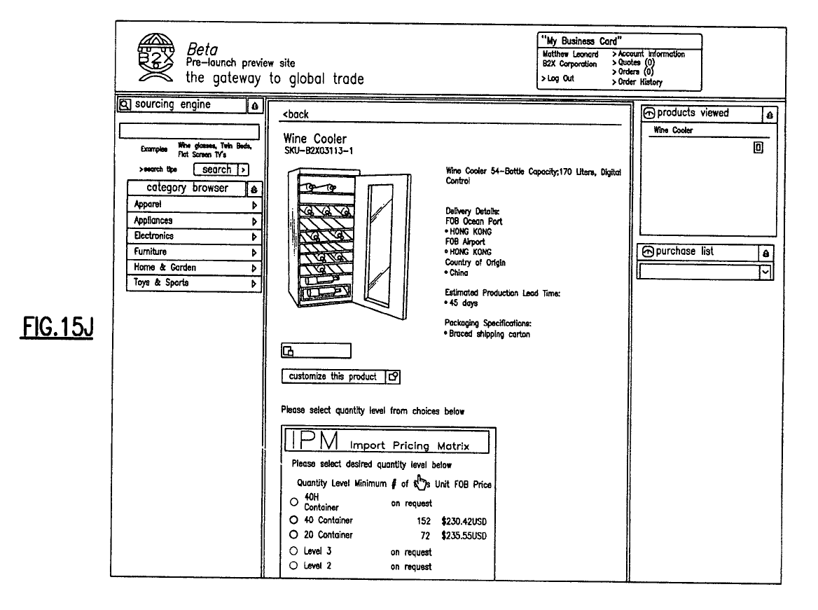

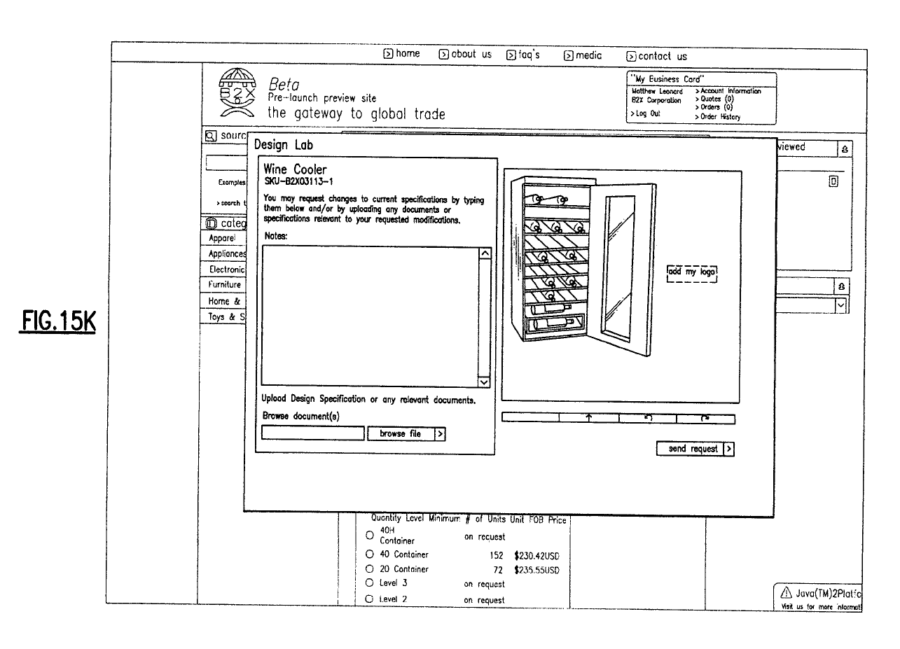

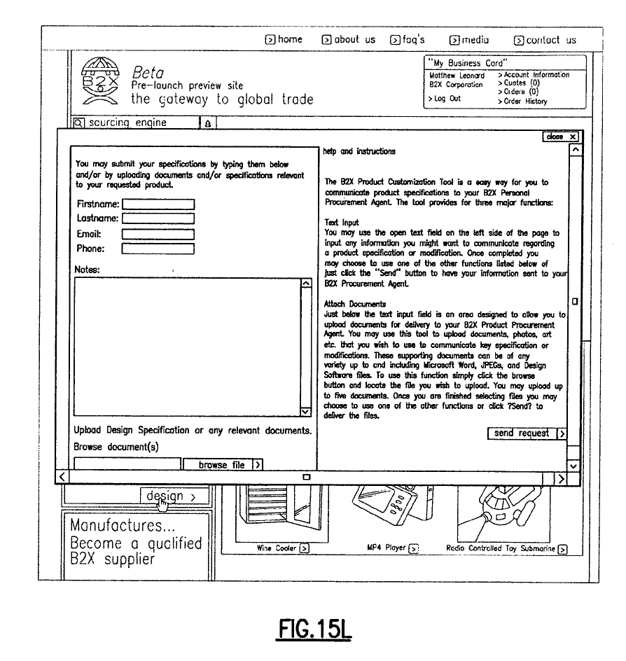

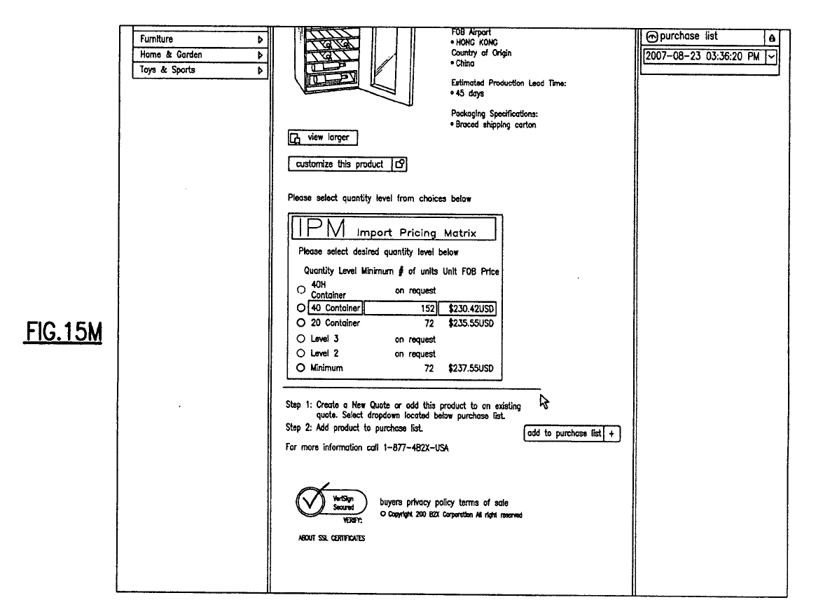

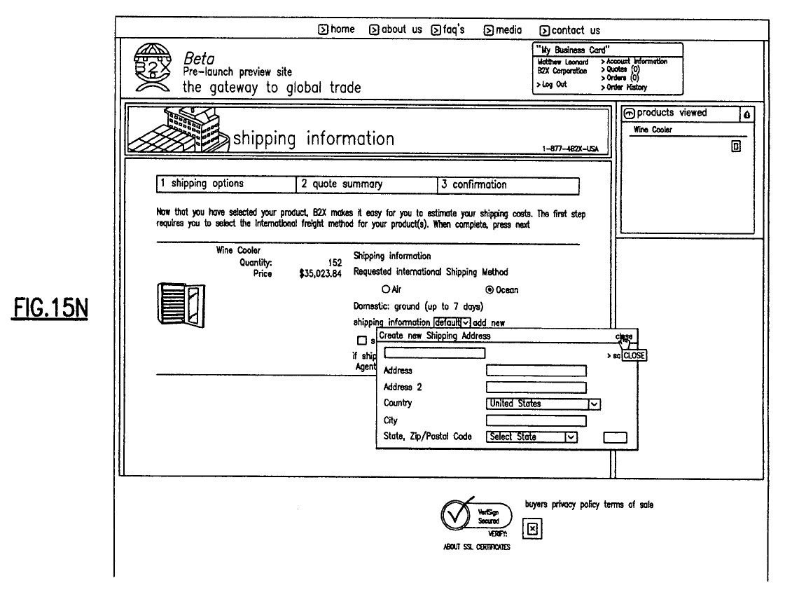

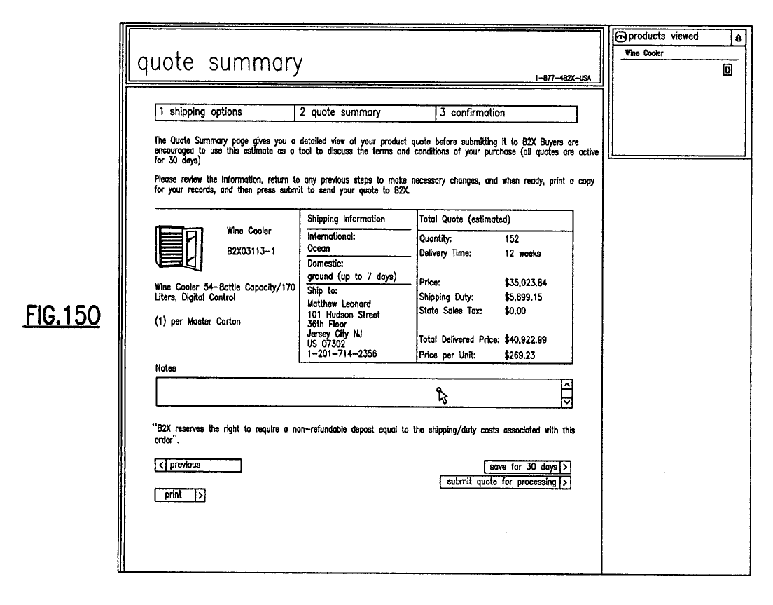

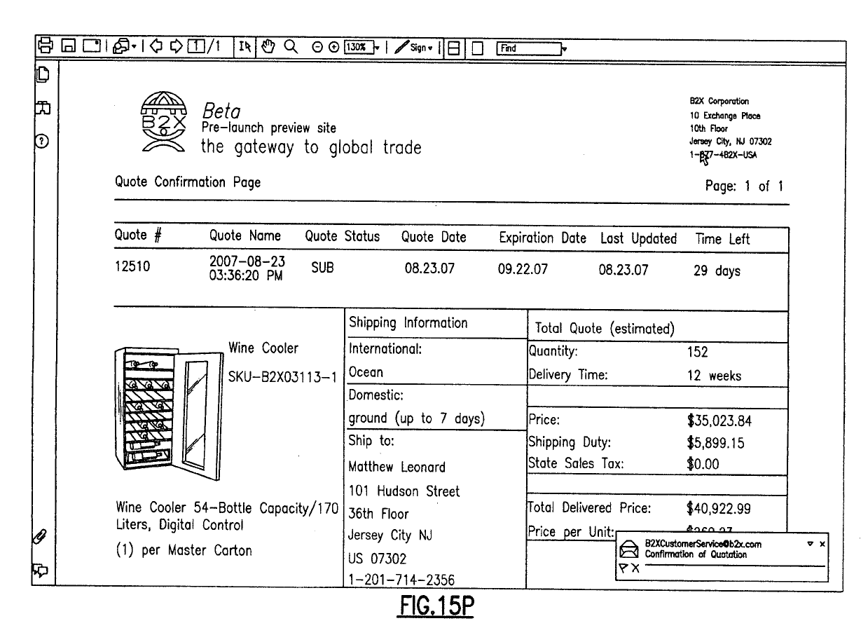

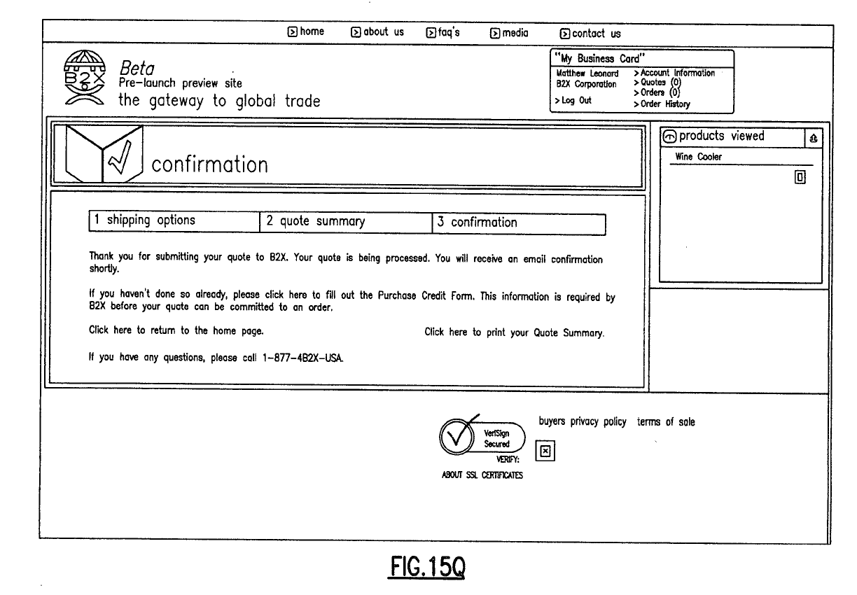

FIGS. 15A-H show an implementation of a shopping user interface in one embodiment of Procurer operation. In FIG. 15A, a user has logged in, as indicated by the welcome message at 1501, and has searched and/or browsed to the category of “glassware”. Consequently, a link to the category of interest is shown at 1502, including an indication of the total number of results contained therein. There are also links to allow a user to view the category hierarchy of which “glassware” is a subcategory 1503 or the eight subcategories of the “glassware” category 1504. The page further includes links to similar products and/or categories 1505 (e.g., ceramics, bakeware, barware, vases, and/or the like), related products and/or categories 1507 (e.g., other table-setting, food-service, and/or kitchen items, and/or the like), and a link to a category directory 1509. Furthermore, because the user has logged in, the Procurer has access to the user's activity history and/or profile. Consequently, it is able to provide a list of products 1511 that the user has recently viewed, selected, requested and/or received quotes for, ordered, and/or the like. There is also a link included to allow the user to generate a custom catalog containing more information about recent products 1513.

FIG. 15B shows the same view as FIG. 15A, except with expanded views of the category hierarchy 1515, in which the “glassware” category is found, and of the eight subcategories of the “glassware” category 1517. Selection of the “wine glasses” subcategory yields the view shown in FIG. 15C, wherein a selection of products matching the subcategory are displayed, such as in a catalog-style format. In the displayed implementation, a “sort by” window 1519 provides a user with a variety of selectable menu items by which he or she may narrow down and/or rearrange the displayed products based on criteria such as product style, product size, product-specific features (e.g., whether the glassware product is dishwasher and/or microwave safe), product set characteristics, and/or the like. In alternative implementations, other sorting and/or narrowing criteria may be available as well, such as alphabetical sorting, price sorting, product type, country of origin, vendor and/or manufacturer name, and/or the like. A user may also manipulate interface elements to adjust catalog display characteristics, such as the number of items displayed that is controlled by a slider widget 1521 in the displayed implementation. Each product in the catalog may be displayed with an abridged version of the product attributes display 1523, such as may include a picture, a brief product description, a product name and/or identification number, and/or the like.

Selection of a clickable catalog element, such as that shown at 1523 in FIG. 15C, may yield a full product attributes display page, such as that shown in FIG. 15D. This page may include more detailed information about a given product in order to inform a user about the product before he or she decides to seek a quote, seek a sample, order the product, and/or the like. Among the product attributes displayed are: a product name and/or title 1525; a manufacturer name and/or identification 1527; associated descriptive symbols pertaining to guarantees, warranties, delivery details, regulations, sample and/or insurance availability, certifications, and/or the like 1529; a product photo, images, diagrams, blueprints, design specifications, and/or the like 1531; key product specifications 1533, such as color, dimensions, material, styles and/or customizability, uses, descriptions, and/or the like; payment details 1535; order limits 1537, such as minimum order, maximum order, limit per customer, and/or the like; delivery details 1539, such as point of origin, shipping and/or transit locations, and/or the like; lead time 1541, which may describe the time prior to shipping in which the order may be processed, the product may be manufactured, and/or the like; and/or the like.

The page also includes clickable interface elements to allow the user to receive enlarged views of product images 1543; to add the product to a basket 1545 for subsequent requests of product samples, quotes, orders, and/or the like; to customize the product 1547; and/or the like. FIG. 15E shows the same product attributes display page as FIG. 15D when the mouse pointer is moved over one of the descriptive symbols 1529. The result, in the displayed implementation, is a pop-up window 1549 displaying specific information about the product feature represented by the corresponding symbol. For example, in FIG. 15E, moving the mouse pointer over the industry certification symbol causes the Procurer to query a product profile to extract the specific industry certification information corresponding to the displayed product.

Clicking on the “Customize it!” button 1547 in FIG. 15D may yield the DesignLab pop-up window interface 1550 shown in FIG. 15F, which empowers a user to provide detailed customization specifications and requests to manufacturers, vendors, and/or the like with respect to a particular product. For example, for the 5.3 oz. wine glass, the user may specify a desired color, height, volume, and/or base material other than those displayed in the product attributes display page via the fields shown at 1551. In one implementation, these fields may be implemented as pull-down menus, radio button menus, and/or the like, while in another implementation, the fields may be implemented as text boxes admitting arbitrary user inputs. The interface may also provide a text box 1553 wherein a user may enter any notes, questions, and/or special instructions regarding his or her particular customization requirements and/or other product attributes. The interface further allows the user to upload one or more design specs or other pertinent documents 1555. A drawing area 1557, including whiteboard and/or art board tabs, may present the user with an image of the product and allow him or her to draw modifications and/or customizations directly thereon using a variety of tools, such as drawing tools or text tools. Finally, the DesignLab window 1550 includes a chat area 1559 whereby a user may exchange instant messages, and/or the like, with one or more Procurer agents, vendors, manufacturers, and/or the like in order to coordinate product specifications or customizations.

FIG. 15G shows a pop-up window 1561 corresponding to the DesignLab drawing tool in one implementation. The window allows the user to select from a variety of pen styles 1563 as well as a pen size and/or color 1565. With the drawing tool, the user may draw on the product image within the whiteboard and/or art board areas of the DesignLab interface to specify desired customizations 1567. The text tool may also be employed to incorporate text in the whiteboard drawing 1569. Customizations entered by a user may, in one implementation, be incorporated into a report and provided to a vendor and/or manufacturer. The vendor and/or manufacturer may subsequently provide a confirmation and/or response, wherein the feasibility of the customization, costs, questions, concerns, and/or the like are specified.

FIG. 15H shows an alternative implementation of a product attributes display page in another embodiment of Procurer operation. The page in this implementation is similar to that shown in FIG. 15D but for a few differences. The present implementation includes: a link to allow the user to view product packaging 1571; an import price matrix (IPM) 1573, whereby a user may select a quantity level for the given product with corresponding number of units and unit freight on board (FOB) price; and a display of the user's trade business card, messages, activities, and/or the like 1575. The IPM 1573 may relate shipping methods, shipping time, lead production time, pricing, and/or the like, and IPM entries may be determined by reference to a logistics module and/or manufacturer entered data.

In one implementation, a seller, manufacturer, vendor, and/or the like may be allowed to submit IPM information for a given product and/or collection of products. For example, an interface may be provided containing text fields, radio buttons, and/or other interface elements enabling the seller to input quantity levels, number of product units corresponding to each quantity level, a unit FOB, a production price per unit, a shipping time, a production time, and/or the like. FIGS. 15I-15Q illustrate additional aspects of the procurement product selection functionality associated with various implementations of the Procurer.

### Generating Quotes and Sales Orders

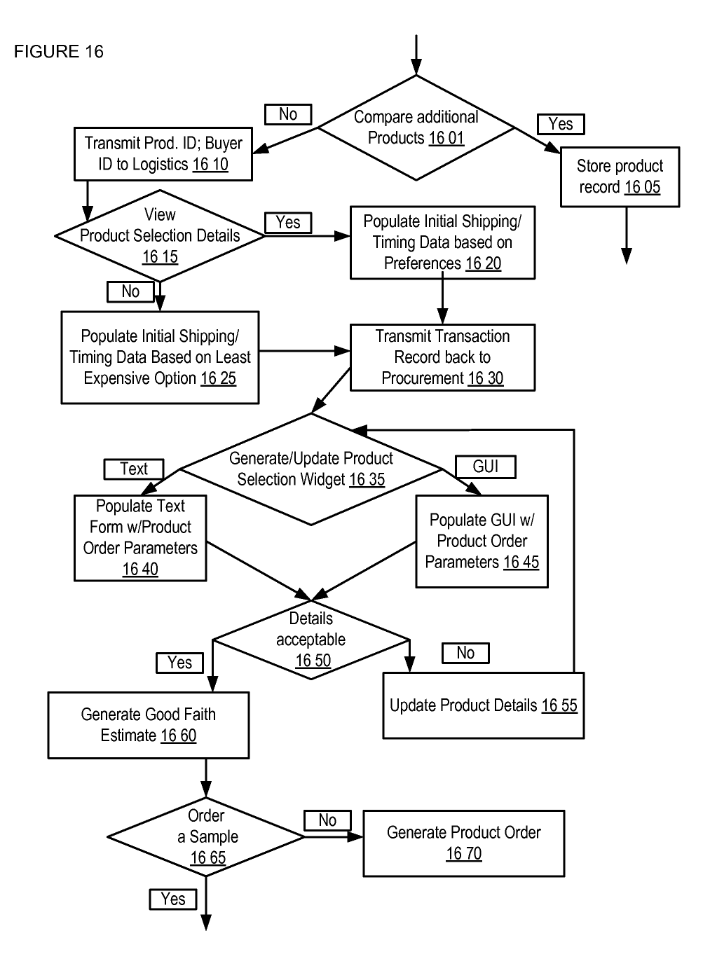

Once a user has selected a product or products, he or she may proceed to populate a personal product datasheet and/or transaction record, receive quotes and/or good faith estimates of prices and/or delivery times, request samples, place product orders, and/or the like. FIG. 16 shows an implementation of logic flow for product post-selection in one embodiment of Procurer operation. A determination is made as to whether the user desires to compare and/or add additional products to those already selected 1601. If so, a record of the products selected thus far is stored 1605 and the user is allowed to proceed with procuring additional products. Otherwise, product identifiers and/or buyer identifiers are transmitted to a logistics module 1610 for determination of pricing and/or shipping/timing data.

The system checks whether a user is an authorized user that has provided product/logistics selection preferences. For example, if the user is not registered, the Procurer may populate initial shipping/timing data based on a default option (e.g., least expensive logistics solution) 1625. In alternative implementations, the default option may be to populate pricing data based on a fastest timing option, to populate pricing and timing data based on a two-parameter optimization rule, and/or the like. If, on the other hand, the user is a registered user, initial pricing and/or timing data may be populated based on user preferences 1620. The transaction record, including initial timing, shipping, and/or pricing data, is subsequently returned to a procurement process 1630, and may be used to generate and/or update a product selection details interface widget 1635.

In alternate implementations, the interface widget may comprise a text form populated with product order parameters 1640, such as the IPM described in FIG. 15, or a graphical user interface (GUI) populated with product order parameters, such as that shown in FIG. 17. A determination is made at 1650 as to whether the details of the product order parameters are acceptable 1650 and, if not, then product order details are updated 1655, and the flow returns to 1635. Otherwise, a good faith estimate is generated 1660 based on the existing product order details, and the user may be provided with the opportunity to order a sample for qualifying products 1665. If a sample is ordered, the sample order may be relayed to a manufacturer, vendor, and/or the like, and the transaction record corresponding to the selected products may be stored until later retrieval. If no sample is desired, then a product order based on the selected and/or generated product order details may be generated at 1670 and/or supplied to a logistics component for subsequent order processing.

FIG. 17 shows an implementation of a user interface for generating a good faith estimate quote, requesting a sample, and other product post-selection activities in one embodiment of Procurer operation. The interface includes a top bar 1701 that may incorporate Procurer and/or product branding, global navigation tools, utility navigation tools, a search box, and/or the like. A heading for the window is provided at 1705, including the product name, a notice that the window provides a “good faith estimate” of landed price, delivery time, and/or the like, and a legal disclaimer.

A User Input window is included at 1710, wherein a user may manipulate interface elements to specify a desired product price and/or quantity 1720 (e.g., pricing level based on quantity), manufacturer's production time 1725, shipping method/time 1730, and/or the like. In the displayed implementation, the interface elements are slider widgets, however a wide variety of other interface elements may also be employed, such as but not limited to pull-down menus, text boxes, dials, radio buttons, and/or the like. As part of the shipping information, the user may also be asked to provide destination information, such as a zip code or a state 1715. In some implementations, this destination information may partially determine the methods and/or prices of shipping available to the customer.

When values for each of the interface elements in 1710 have been set, a report of prices and/or delivery times may be updated and displayed to the user. In one implementation, price and/or delivery time reports may be updated in real time as the user manipulates the interface elements in 1710. In the displayed implementation, the report includes sections delineating: estimated results per unit, including a product price, quantity, shipping charge, delivery time, state sales tax, landed price per unit, additional shipping details 1740, and/or the like; estimated total results 1745, such as for similar categories as those in 1740; and running totals 1750 for, e.g., price, shipping charges, and tax categories across all saved products.

A button is provided at 1755 to save the current estimates in a transaction record and/or user profile. The interface also includes buttons to permit the user to order a sample 1760 and/or create a quotation 1765, such as may be based on the good faith estimate. A user may also provide a resale certificate via the box at 1770. Finally, the interface includes a bottom bar 1775, which may incorporate additional navigation components, copyright information, links to email and/or contact options, and/or the like.

In one implementation, the interface in FIG. 17 may be employed as part of a search interface prior to the selection of products by a user. For example, a user may select desired pricing, shipping, and/or timing parameters in conjunction with one or more search terms in order to retrieve results having a desired bare and/or landed price per unit; available shipping method; shipping, production, and/or total delivery time; and/or the like. Similarly, the interface may be displayed after an initial set of search results have been retrieved in response to a search query in order to provide the user with a means to narrow and/or target the results to specific needs or requirements. In another implementation, the interface may be displayed after a user selects one or more products and enters additional purchase and/or delivery information (e.g., destination, insurance requirements, size of order, etc.) to enable the user to explore product pricing and timing possibilities before receiving a final quote and/or placing a purchase order.

For example, a user may set a bare price per unit, production time, and shipping method, in order to be provided an estimate of a landed price per unit, total price, and/or the like. In some implementations, particular values of one or more pricing and/or timing parameters may be constrained by values set for other parameters. For example, a user setting a particularly low value for bare price per unit may be prevented from setting too low a value for production time if a manufacturer specifies that only longer production times may yield such a low bare price per unit.

In yet another implementation, a user may be provided with one or more interface elements (e.g., buttons) implementing price and/or timing optimization to be applied in conjunction with a search and/or sorting search results. For example, a user may select a button to determine what combination of production price, shipping method, and production time that yields the lowest landed price per unit. In another example, a user may select a button to determine what combination of parameters yields the fastest overall delivery time. In yet another example, a user may specify a constrained optimization, such as determining the parameter combination that yields the lowest landed price per unit with total delivery time between one and two weeks.

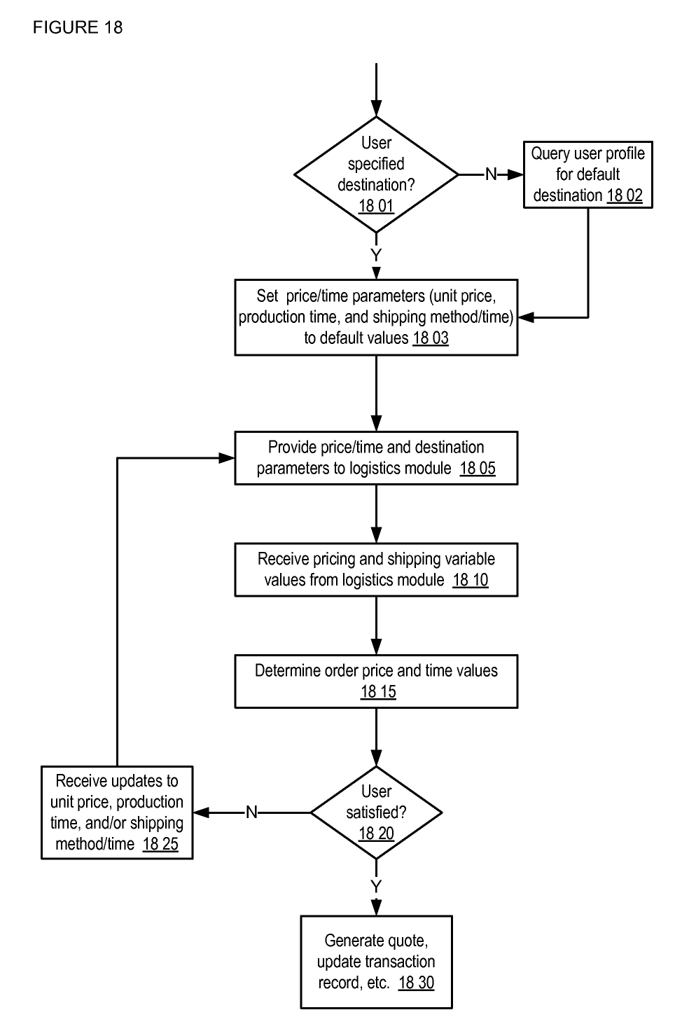

FIG. 18 shows an implementation of logic flow underlying good faith estimate generation in one embodiment of Procurer operation. When a user selects a product and is first presented with a good faith estimation interface, the Procurer may check whether the user has specified a delivery destination for the product 1801. If not, then the Procurer may query a user profile to extract a default destination 1802. At 1803, the Procurer selects default initial settings for parameters directed to price, time, shipping method, and/or the like.

For example, the Procurer may be configured to select initial parameters that minimize the landed price per unit. These parameters are supplied to a logistics module 1805 that is capable of analyzing details of the transaction transit costs, including overland transport, shipping, customs, taxes and tariffs, inspection costs, distribution costs, storage costs, and/or the like to arrive at overall cost and delivery time estimates. Further details surrounding the operation of the logistics module are provided in related co-pending application SYSTEMS, METHODS AND APPARATUSES FOR IMPORTATION AND EXPORTATION TRANSACTION LOGISTICS FACILITATION”, Armand Rousso, filed Sep. 28, 2007, Attorney Docket No. 17854-004PC, which is incorporated in its entirety herein by reference.

The Procurer receives processed pricing and shipping variable values from the logistics module at 1810 and uses them to determine order price and delivery time values for display 1815. In an alternative implementation, the order price and delivery time values that are displayed are supplied directly by the logistics module. A determination is made at 1820 as to whether the user is satisfied with the generated pricing and timing parameters for the order and, if not, then the Procurer receives updated pricing, timing, and/or shipping parameters 1825, based on which a new determination of price and delivery time values may be made. Otherwise, if the user is satisfied, then the Procurer may proceed to generate a quote, update the transaction record, generate and/or process a purchase and/or sales order, and/or the like 1830.

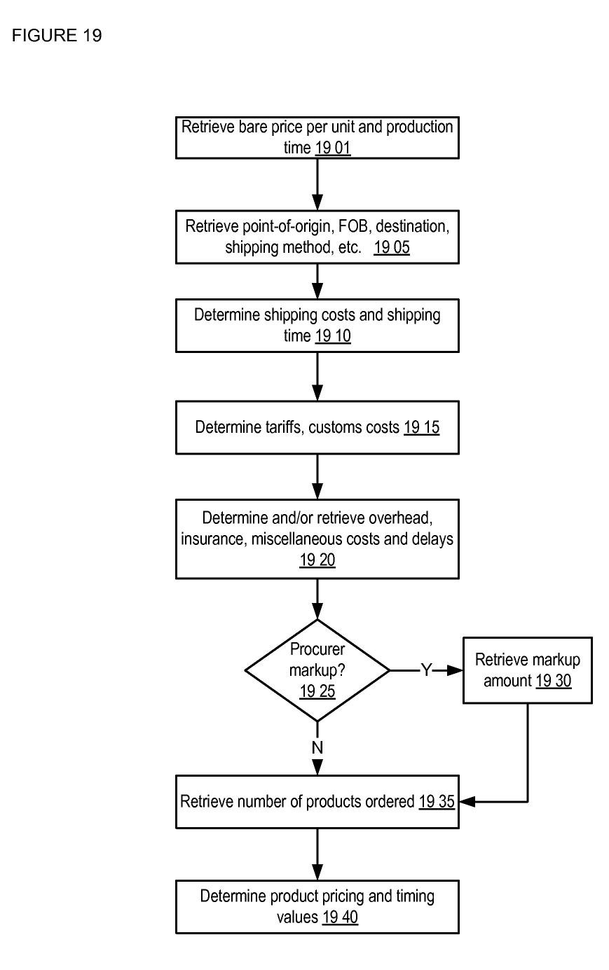

FIG. 19 shows an implementation of logic flow for good faith estimation in another embodiment of Procurer operation. A bare price per unit and production time are retrieved at 1901, such as from a user via the interface described in FIG. 17. Additional information pertaining to the transaction may also be retrieved, such as a product point-of-origin, FOB, destination, shipping method, and/or the like 1905. Based on some of the retrieved parameters and/or values, the Procurer may determine a shipping costs and/or shipping time 1910, such as by making reference to one or more stored shipping cost and/or timing tables. Such tables may include information pertaining to the prices charged by shipping companies for different methods of shipping, as well as the amount of time that such methods may be expected to take.

Based on the expected shipping route, the Procurer may further determine the amount of tariffs, customs costs, and/or the like impacting landed product price and/or delivery time 1915. The Procurer may also determine and/or retrieve additional costs and/or timing delays, such as may be associated with overhead, insurance, guarantees or warranties, shipping holds and/or other trade restrictions, storage, distribution, inspection, and/or the like 1920. A determination is made at 1925 as to whether an additional markup may be applied by the Procurer itself. If so, then the amount of that markup is retrieved and/or determined based on other transaction parameters at 1930. The total number of products ordered is retrieved at 1935, and the Procurer may then determine total product pricing and/or timing values at 1940. For example, the Procurer may sum the bare price per unit, shipping costs, tariffs and/or customs costs, overhead costs, insurance costs, and Procurer markup to determine a total price. The total price may also be divided by the number of products ordered to determine a landed price per unit. In another example, the Procurer may sum the production time, shipping time, storage times, expected delay times, and/or the like to determine a total delivery time. In one implementation, the Procurer may operate in coordination with a logistics module, which may provide information pertaining to shipping costs and timing, tariffs, production costs and timing, transit delays, routing, and/or any other issues pertaining to the shipping and/or product purchasing logistics.

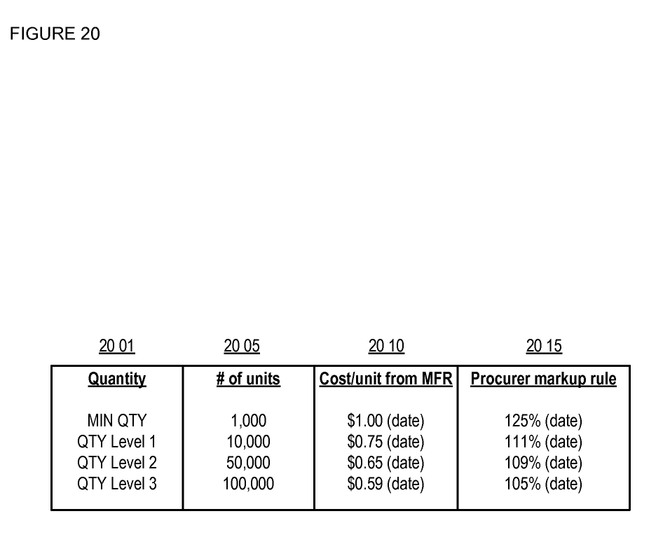

FIG. 20 shows an example of a product markup table in one embodiment of Procurer operation. The table includes columns for quantity category 2001, number of units within each quantity category 2005, the cost per unit from the manufacturer 2010, and the Procurer markup rule corresponding to each quantity category 2015. For example, a buyer of the minimum quantity category containing 1,000 units of a product may pay a total of $2.25 per unit, based on a cost of $1.00 from the manufacturer with a 125% Procurer markup. The values in the table shown in the figure provide for a lower manufacturer cost per unit as well as a lower procurer markup for larger quantity categories, amounting to a volume buying discount. Each cost and markup value in the table may also be provided with an associated date, which may indicate the values date of creation, date of expiration, and/or the like.

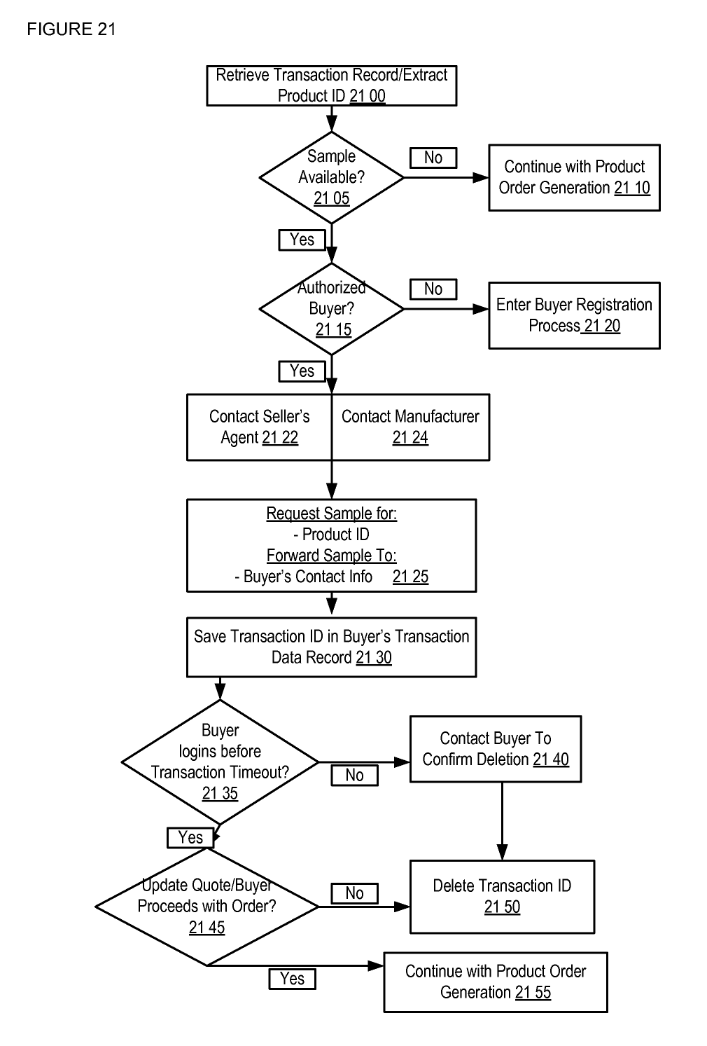

FIG. 21 shows an implementation of logic flow for sample request facilitation in one embodiment of Procurer operation. A transaction record may be retrieved and a product ID extracted therefrom 2100, after which a determination is made as to whether samples are available for the selected product 2105. If not, then the sample facilitation process exits, and the customer may be directed to continue product order generation 2110. In an alternate implementation, one or more similar products having available samples may be suggested to the user in lieu of the initially selected product. If a sample is available, then a determination is made as to whether the buyer has demonstrated a sufficient level of authorization 2115.

If not, then the Procurer may direct the buyer to the buyer registration process and/or other buyer verification or purchase registration processes 2120 before allowing him or her to proceed with a sample order or transaction. If the buyer is authorized, then the Procurer may, in alternative implementations, contact a seller's agent 2122 and/or contact a manufacturer 2124 in order to request that a sample, matching the retrieved product ID, be sent to a location specified by the buyer's contact info 2125. The Procurer may further save a transaction ID corresponding to the selected product or products and/or the sample request in the buyer's transaction data record and/or profile 2130.

As time passes between the sample request and a time that the buyer logs in again, a determination is made at 2135 as to whether the buyer has logged in before a timeout has occurred with respect to the transaction corresponding to the ordered sample. In one implementation, the Procurer may note the time that a buyer requests a sample and may automatically deliver periodic reminders to act on the transaction before the transaction timeout period has expired. If the buyer fails to log in before this timeout, then the Procurer may contact the buyer to inform them of the expiration and confirm deletion of the transaction 2140. The transaction ID may subsequently be deleted from the buyer's transaction record at 2150. If the buyer returns to the system in a timely manner, then the quote may or may not be updated (such as depending on whether or not the transaction parameters are deemed to remain valid), and the buyer may be presented with the option to proceed with the transaction 2145. If the option is declined, then the transaction ID may be deleted from the buyer's transaction record 2150. Otherwise, a product order is generated 2155, and the Procurer passes the order along to logistics and/or payment facilitation modules to effectuate realization of the transaction.

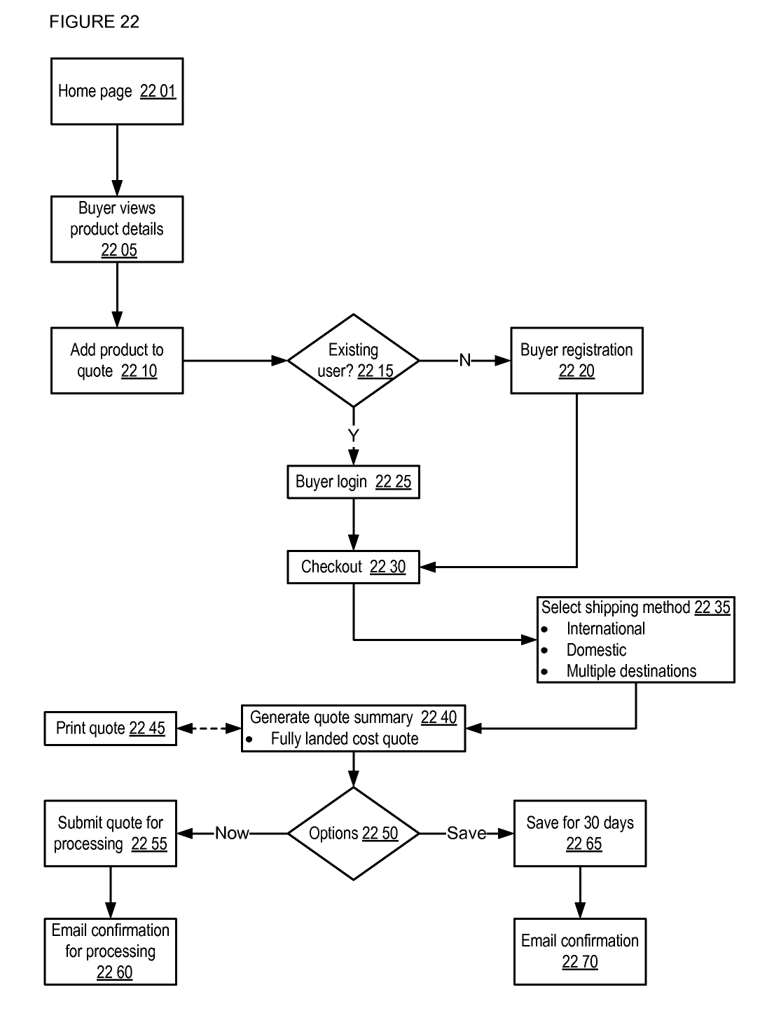

FIG. 22 shows an implementation of logic flow for generating product quotes in one embodiment of Procurer operation. A user navigates from the home page at 2201 to search, browse, or otherwise view and select products. For selected products, the user may be presented with a view of a product attributes display 2205, and the user may elect to add one or more products to the quote being generated 2210. Once products are added, a determination is made as to whether the user is new or has already registered 2215. If the user is new, then he or she is directed to a buyer registration process such as those described previously 2220.

Otherwise, if the buyer hasn't already logged in, he or she is requested to do so at 2225. To proceed with the quoting process, the buyer may then elect to checkout 2230, at which point the Procurer will request that the buyer select a shipping method 2235 and/or other aspects of shipping, such as whether shipping is international, domestic, to multiple destinations, and/or the like. The quote summary is subsequently generated, and may include a fully landed cost quote for the selected products 2240. At this time, the buyer may be allowed to print the quote 2245, and may be provided with options 2250 for further processing. For example, the buyer may submit the quote for immediate processing 2255, causing the Procurer to provide an email confirmation for processing 2260 and to carry through with subsequent finalizing of the quote, generation of a sales and/or purchase order, and/or the like. Alternatively, the buyer may save the quote for a specified period of time (e.g., 30 days) 2265, within which he or she may decide whether or not to pursue a purchase order. An email confirmation of the quote may be sent to the buyer at 2270.

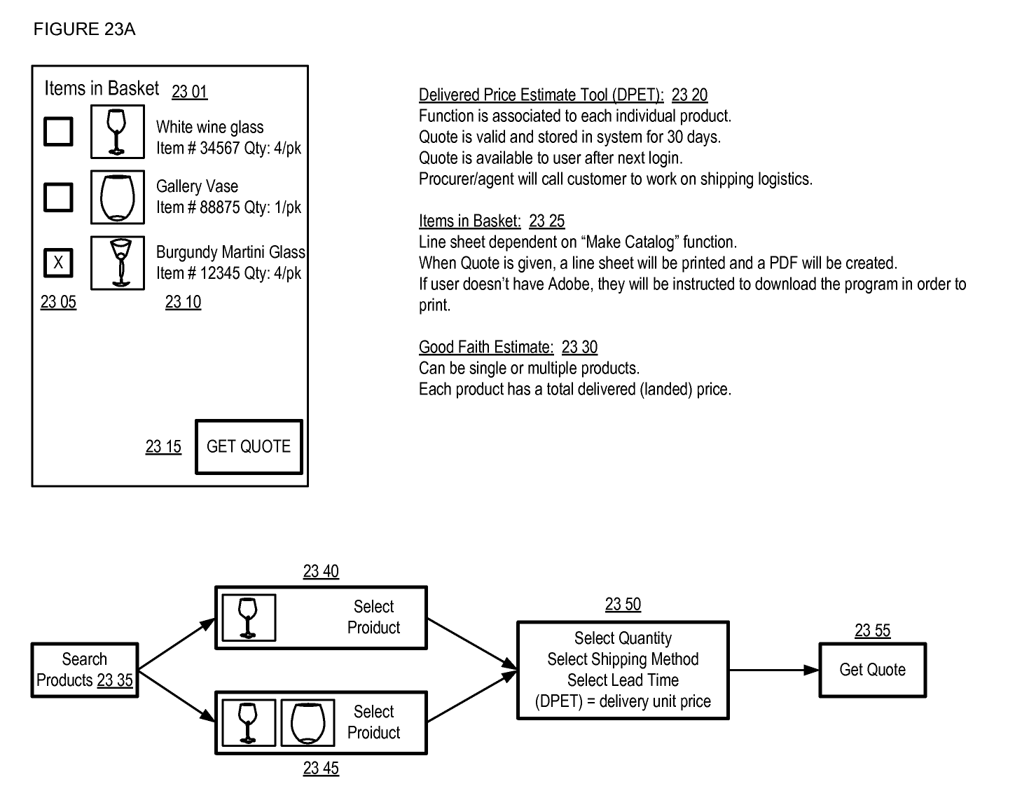

FIG. 23A shows aspects of quote and product line sheet generation in particular embodiments of Procurer operation. An exemplary line sheet is shown at 2301, displaying a listing of items that a customer has added to his or her basket. Such items may be added, for example, to compare products and prices from different manufacturers, to collect components of a larger project, and/or the like. The line sheet may provide check boxes 2305 associated with each product entry 2310 that a user may click to add products to a quote, which may then be generated by selecting a “Get Quote” button 2315. FIG. 23 further includes brief descriptions of aspects of Procurer components in particular implementations:

A delivered price estimate tool 2320 (an example of a DPET is shown in FIG. 17) which may be associated to each individual product, may generate a quote that is valid for a specified period of time and may be accessible when a user logs in later to the system, and may induce a Procurer agent to contact the customer to coordinate transaction logistics.

A line sheet, or “Items in Basket” component 2325 that may be generated with a “Make Catalog” button and may be generated automatically in response to a quote generation request for all products included in the quote calculation. In one implementation, the line sheet may be an Adobe PDF document, and a user may be instructed to download Adobe if he or she does not already have it installed at the time of line sheet generation.

A good faith estimate 2330 may be provided in response to manipulation of a delivered price estimate tool, may be included in a quote, may be based on a single or multiple selected products, may provide a total delivered and/or landed price for each product in a basket or for the a collection of products, and/or the like.

FIG. 23A further includes a particular implementation of logic flow for quote generation. A customer may begin by searching and/or browsing products and/or product attributes display pages 2335, and may select one 2340 or more 2345 products for inclusion in a given quote determination. Once products have been selected, the user and/or Procurer may further select product quantities, shipping methods, lead times and/or product manufacturing times, and/or the like for input into a delivery price estimate tool to yield a delivery and/or landed price per unit 2350. This delivery and/or landed price per unit may subsequently be incorporated into a quote that is then provided for display to the customer 2355.

FIG. 23B shows another implementation of a product line sheet 2360 in another embodiment of Procurer operation.

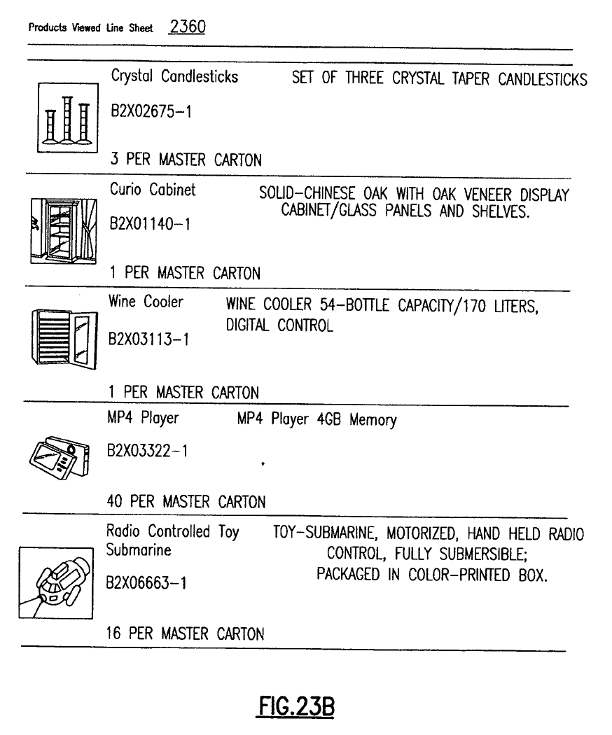

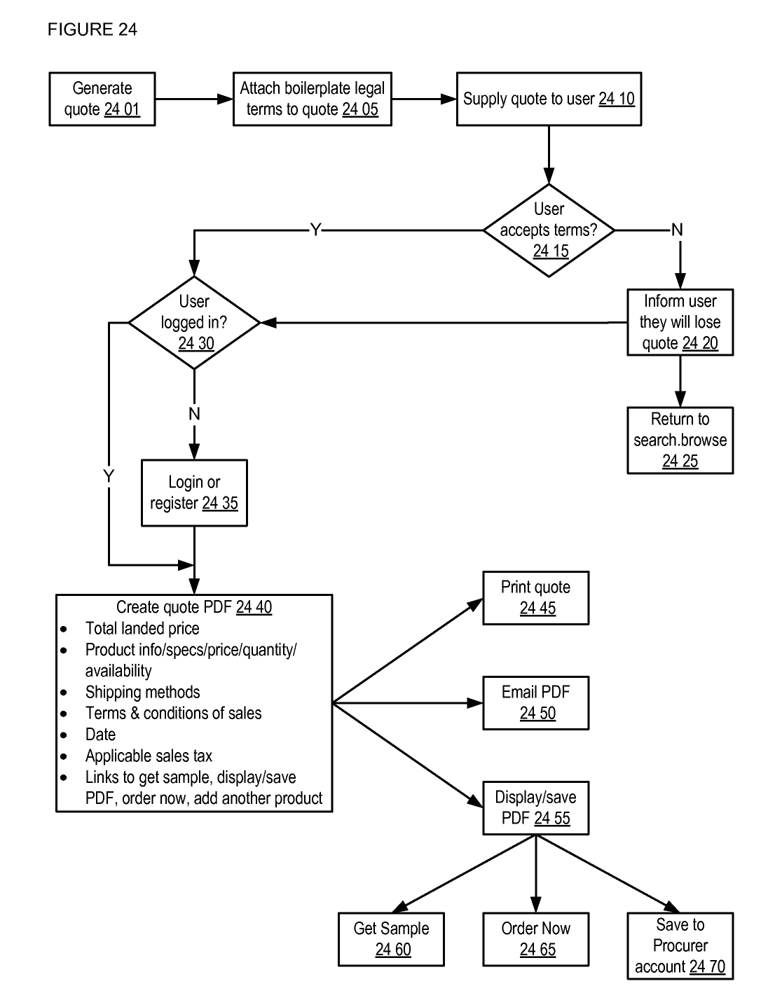

FIG. 24 shows an implementation of logic flow for generation of an official quote in another embodiment of Procurer operation. The user selects a quote generation option at 2401 based on a selection of one or more products. The Procurer may attach terms and conditions, legal boilerplate, and/or the like to the quote 2405 and provide the quote for display to the user 2410, at which time the user may elect to accept or decline the associated terms and conditions 2415. If declined, then the user may be informed that he or she will lose the quote and may be asked whether to proceed or cancel 2420.

If the user decides to proceed, the quote may be canceled 2425 and the user is allowed to return to searching and/or browsing products. Otherwise, if the user accepts the terms and conditions associated with the quote, then the Procurer may determine whether or not the user has registered and/or logged in 2430. If not, then the user may be requested to login and/or register 2435. Once the user is logged in, the Procurer may create an official quote document, such as a PDF 2440, which may contain a variety of quote and/or transactional information, such as but not limited to: a total landed price, a landed price per unit, product information, specifications, price, quantity ordered, product availability, available and/or selected shipping methods, terms and conditions of sales, the date and/or time of the request, applicable sales tax, links to acquire a sample, display and/or save the quote PDF, to order the product, to add another product, and/or the like.

With the official quote document in hand, the user may have a variety of options with respect to the transaction, such as but not limited to: printing the quote 2445; emailing the quote PDF 2450; displaying and/or saving the PDF 2455; and/or the like. The user may be provided with links within a displayed quote PDF that allow for the user to directly request a sample 2460, to place an order based on the quote 2465, to save the quote to a user account within the Procurer system 2470, and/or the like.

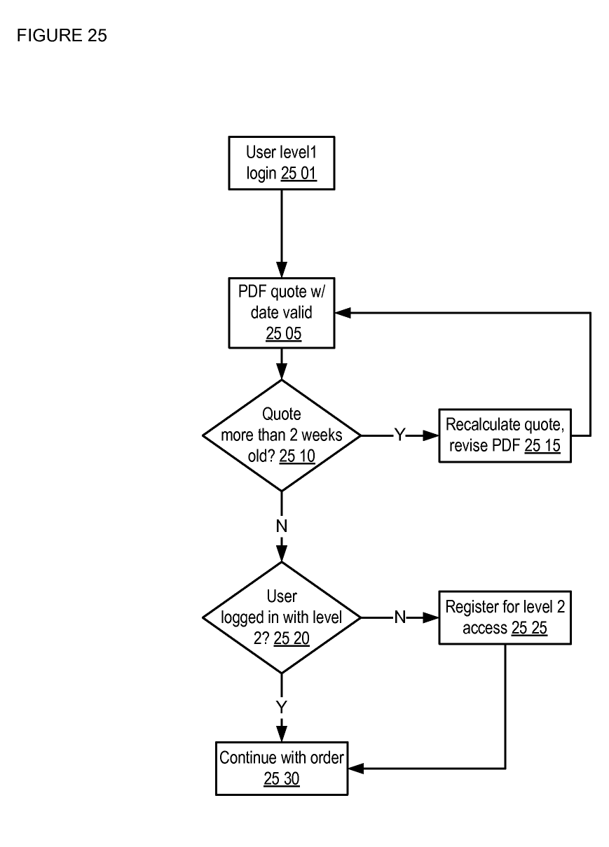

FIG. 25 shows an implementation of logic flow for quote finalization and order generation in one embodiment of Procurer operation. A user with level 1 access logs in at 2501 and generates and/or retrieves an official quote document with a valid date 2505 based on a selection of products. A determination is made at 2510 as to whether the quote is older than a specified upper limit (e.g., 2 weeks). If so, then the Procurer may recalculate quote parameters and generate a revised official quote document based on updated transactional and/or external parameter values 2515. For a sufficiently recent official quote document, a determination is made at 2520 as to whether the user has logged in with level 2 access 2520, such as may be required for moving beyond official quote document generation to generate a purchase and/or sales order. If the user has not logged in with the appropriate level of access authorization, then the user may be requested to register for level 2 access 2525. Otherwise, he or she may be allowed to proceed to generate a purchase and/or sales order based on the official quote 2530.

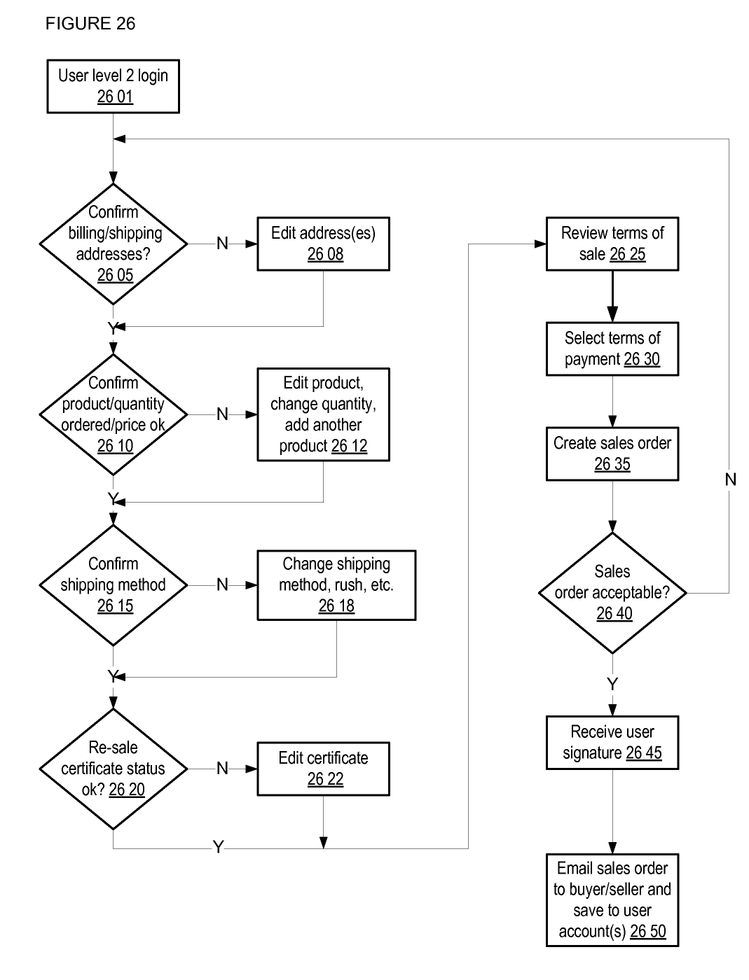

FIG. 26 shows an implementation of logic flow for sales order generation in one embodiment of Procurer operation. A user with level 2 access may be required to log in 2601 prior to being allowed to proceed with sales order generation. He or she may then be provided with a series of confirmation messages in order to ensure proper user information and/or transactional details. A billing and/or shipping address confirmation message may be provided 2605 and, if corrections are needed, the user may be allowed to edit one or more pertinent addresses 2608. A product type, quantity ordered, and/or price confirmation message may then be provided 2610, based on which a user may be allowed to edit ordered products, change quantities, add or remove products, and/or the like 2612.

A shipping method confirmation message may then be provided 2615, based on which a user may be allowed to change requested shipping methods, request expedited and/or rush delivery, and/or the like 2618. In some implementations, a user may be requested to generate a new official quote prior to proceeding with sales order generation if he or she edits particular transactional parameters, such as products ordered, quantities, shipping methods, and/or the like. The buyer, seller, Procurer administrator, and/or the like may then be requested to confirm the acceptability of a re-sale certificate 2620, which may subsequently be edited 2622. The buyer is then provided with the opportunity to review terms of sale 2625 and to select terms of payment 2630 before the Procurer creates a sales order 2635.

The sales order may be provided for display and/or review to the buyer 2640 and, if unacceptable, the buyer may be allowed to edit personal and/or transactional information. Otherwise, the sales order may be provided to the buyer to sign and return 2645. Upon receipt of a signed sales order, the Procurer may email the completed sales order to the buyer and one or more sellers associated with the transaction and save the order in buyer and seller accounts 2650. The sales order may subsequently be provided to logistics and/or payment facilitation modules to enable further effectuation of the transaction.

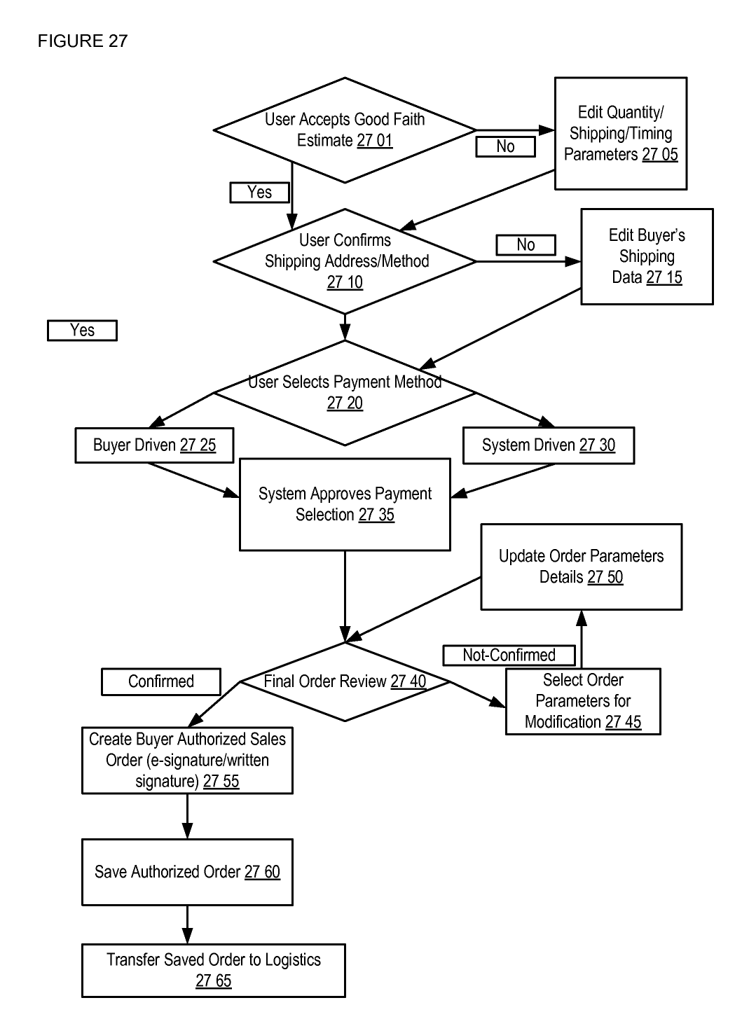

FIG. 27 shows an implementation of logic flow for sales order generation in another embodiment of Procurer operation. A user is requested to accept the good faith estimate generated in conjunction with a quote 2701 and, if the estimate is unacceptable, then the user may be permitted to edit product types, quantities, shipping and/or timing parameters, and/or the like 2705. Once an acceptable good faith estimate has been generated, the user may be requested to confirm delivery address and/or shipping method 2710. If unacceptable, then the buyer may be allowed to edit shipping information at 2715. The buyer may then be provided with a selection of payment methods 2720, such as buyer driven 2725 and/or system driven 2730 payment.

In one implementation, buyer driven payment may comprise direct payment by the buyer to the seller, while system driven payment may comprise payment being provided by the buyer to the Procurement system who acts as an intermediary entity to relay payment to the product manufacturer, vendor, and/or the like. The system approves the buyer's payment selection at 2735 and the buyer is provided with an opportunity to perform a final review and confirmation of order parameters 2740. If not confirmed, then the buyer may be allowed to select order parameters that require modification 2745 and to update corresponding order parameter details 2750. For confirmed orders, the Procurer may generate a sales order and request buyer authorization, such as via an e-signature, written signature, and/or the like 2755. Finally, the authorized sales order may be saved in a transaction record, buyer profile, seller profile, and/or the like at 2760, before being provided to a logistics component 1265 and/or payment facilitation to effectuate further consummation of the transaction.

### Various Applications

The Procurer provides an efficient and effective means for organizing product data, managing transaction participants, and facilitating complex transactions that may be applied to a wide variety of commercial, import-export, and/or trade applications. In some implementations, the Procurer may be configured to form the basis of an online import-export trading system. By providing components to register and authorize new participants from widely separated locations, process product information, provide an online catalog, generate quotes and sales orders, track orders and customer satisfaction, and/or the like to facilitate and process transactions at various scales, the Procurer is capable of navigating the complexities of import-export bureaucracies while providing confidence to participants that transactions will be successfully consummated.

In another implementation, the Procurer may incorporate components that facilitate the formation and/or operation of buying groups. A buying group may comprise a collection of Procurer participants coordinating purchases in order to effectuate volume buying discounts, reduce total shipping costs, insurance costs, tariffs, overhead, and/or the like. Members of a buying group may be notified of a pending transaction by another member of the buying group in order to inform them of coordination opportunities. Alternatively, two Procurer participants purchasing the same product from the same manufacturer may be notified of each other's activities in order to inform them of the possibility of creating a buying group. Cost reductions within a buying group may be considered by Procurer components during good faith estimation of pricing and/or shipping parameter values.

In another implementation, the Procurer may incorporate components that facilitate the development of reciprocal deals between Procurer participants. For example, a first participant, who is both a buyer and a manufacturer, may seek to purchase products from a second participant, who is also both a buyer and a manufacturer. The Procurer may be configured to detect such a situation and notify the participants in order to inform them of the possibility for providing mutually beneficial and/or reciprocal discounts.

In another implementation, the Procurer may be equipped with a host of communication tools, such as instant messaging, blogs, message boards, live chat, audio and/or video conferencing, and/or the like.

In another implementation, the Procurer may provide outsourcing and/or labor hiring opportunities for participants. In addition to products, the Procurer may provide access to overseas labor, including descriptions of labor and/or production capabilities, skills, wages, estimated production times, and/or the like. A customer may select a labor resource to hire for a particular production endeavor and proceed to specify transactional logistics and/or payment facilitation methods in a manner similar to more conventional product purchases.

In another implementation, the Procurer may serve as the basis for a supply chain management system. A buyer may coordinate purchase of various components of a product from different manufacturers which are subsequently supplied to yet another manufacturer for assembly into the final product. Alternatively, a user may coordinate production of a first component, that is subsequently provided for modification and/or augmentation to additional manufacturers.

In another implementation, the Procurer may be configured to admit direct and/or reverse bidding for product prices. Proposed prices may be stored for a period of time during which other participants may propose alternate prices (other buyers in a direct auction, and other sellers in a reverse auction). Price proposals may be subject to limitations (e.g., price ceilings or floors, quantity limits for given price levels, etc.), and all prices may be subject to buyer, seller, and/or Procurer approval.

In another implementation, the Procurer may admit scheduled and/or automated purchasing functionalities. For example, a buyer may be able to schedule a transaction for a future time. He or she may be required to agree in advance to any changes in pricing, shipping, and/or timing parameter values associated with the transaction that take place between the present time and the time of the scheduled transaction. In an alternative implementation, the buyer may be allowed to lock-in a price and/or delivery time for a given product in exchange for paying an extra premium on top of the ordinary product price. The premium may be determined, for example, based on hedging requirements covering the risk associated with changes in transactional parameters, currency exchange rates, shipping rates, insurance rates, and/or the like. In still another implementation, the Procurer may be integrated with a production diagnosis module configured to detect shortages of a given product or component in a production and/or manufacturing facility. Such a shortage may be directly communicated to the Procurer, which may then automatically generate and/or fulfill a quote and/or sales order for the deficient product or component.

In another implementation, the Procurer may be configured to allow users to select display styles corresponding to different countries, languages, currencies, customs, and/or the like. For example, a user may select a particular desired currency in which to display all monetary values. Based on that selection, the Procurer may query a recent and/or real-time currency exchange rate in order to convert monetary values from various points of origin into the desired display currency. Similarly, a user may select a desired language to direct the Procurer to translate product attributes display information, interface components, communications from other participants, and/or the like into the language of choice. The procurer may provide selectable country styles that a user may select from in order to convert all Procurer interfaces and displays into the language, currency, and/or the like corresponding to the selected country.

In another implementation, the Procurer may be configured to display a variety of information pertinent to transactions taking place across international borders in order to facilitate fully informed purchasing. For example, the Procurer may include a display of real-time currency exchange rates for commonly used currencies and/or may admit buyer queries for an exchange rate between two currencies of choice. The Procurer may further provide information pertaining to current insurance rates, shipping rates, delivery times, systemic delays, global trade news, rates for locking-in prices, manufacturer deals, discounts, and/or the like.

In another implementation, the Procurer may admit ratings of participants by other participants, Procurer administrators, and/or the like. For example, upon completion of a transaction, a buyer may be permitted to rate a seller and vice versa. Accumulated ratings may form the basis of a ranking and/or reputation scoring system that may be available for display to future participants entering into transactions with the rated participant. In another example, buyers and/or sellers may rate shippers, insurance carriers, and/or any other ancillary Procurer affiliates. Ratings, rankings, scores, and/or the like associated with Procurer participants and/or affiliates may be considered in determining future visibility, use, patronage, and/or the like. For example, highly rated shipping companies may be employed more frequently by the Procurer, based on availability, than those with lower ratings.

In another implementation, the Procurer may be configured to provide advertisements for products, goods, services, manufacturers, vendors, industries, and/or the like associated with Procurer participants. Participants may be permitted to provide custom advertisements and/or to enter custom information into existing advertisement templates. Advertisements may further include associated keywords, tags, search terms, and/or the like to assist the Procurer with delivering the advertisements to appropriate customer targets. In one implementation, customer purchase behavior may be tracked, recorded, and/or analyzed in order to discern customer product preferences and to provide advertisements based thereon. Customer purchase behavior information may also be provided to manufacturers, vendors, marketers, and/or the like in exchange for a fee. Various advertisers may further be charged a fee for advertisements based on a variety of monetization models, including but not limited to: pay-per-impression, whereby a fee is charged for every instance in which an advertisement is displayed to a user; pay-per-click, whereby a fee is charged for every instance in which a user clicks on or otherwise interacts with an advertisement; pay-per-consummation, whereby a fee is charged for every instance in which a user clicks on or otherwise interacts with an advertisement and subsequently purchases a product or products based on that advertisement; and/or the like. Advertisers may also be charged a fee to purchase search terms that, when entered by a user, lead to the display of selected advertisements. In another implementation, the Procurer may be configured with collaborative filtering capabilities to record consumer purchases and track common associations between purchased products. A customer purchasing a given product in the future may subsequently be directed to other products that customers purchasing the given product have also purchased in the past.

In another implementation, the Procurer may be configured to handle aspects of customer service and complaint management. For example, the Procurer may provide an ombudsperson outlet to allow Procurer participants to express concerns, complaints, and/or the like regarding other participants, products, transactions, and/or the like. The Procurer may further provide agents to assist participants with purchases, questions, searching, and/or any other problems that may arise during the procurement process.

### Procurer Controller

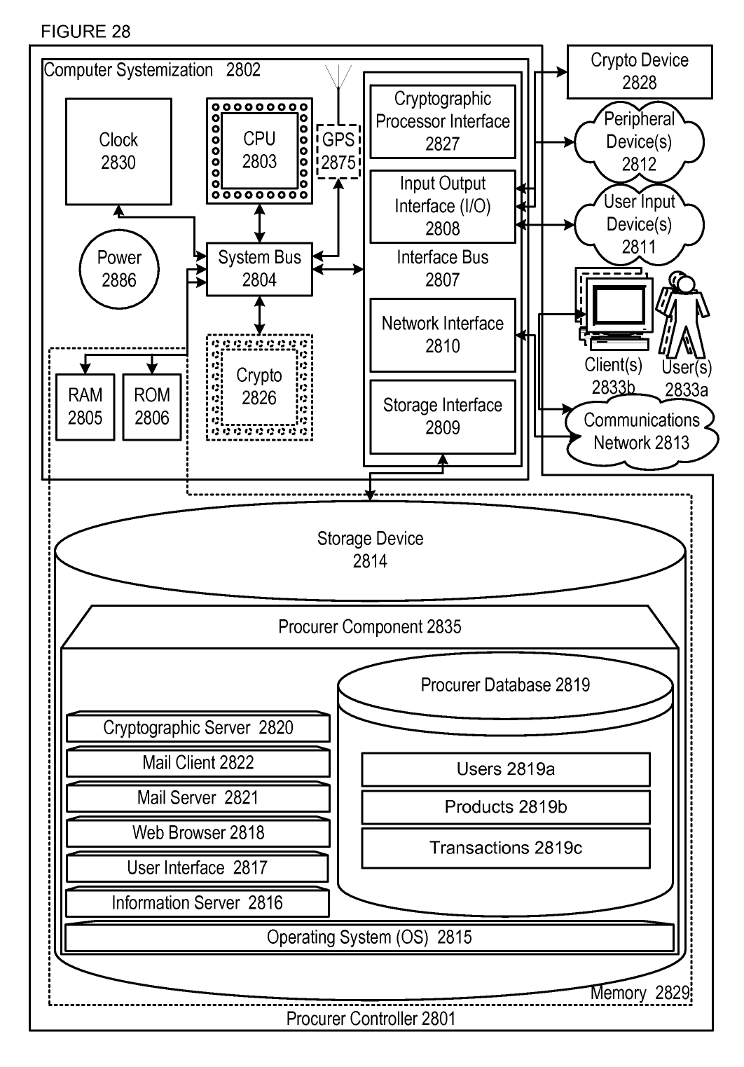

FIG. 28 of the present disclosure illustrates inventive aspects of a Procurer controller 2801 in a block diagram. In this embodiment, the Procurer controller 2801 may serve to aggregate, process, store, search, serve, identify, instruct, generate, match, and/or facilitate interactions with a computer through Procurer technologies, and/or other related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the Procurer controller 2801 may be connected to and/or communicate with entities such as, but not limited to: one or more users from user input devices 2811; peripheral devices 2812; a cryptographic processor device 2828; and/or a communications network 2813.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Procurer controller 2801 may be based on common computer systems that may comprise, but are not limited to, components such as: a computer systemization 2802 connected to memory 2829.

Computer Systemization

A computer systemization 2802 may comprise a clock 2830, central processing unit (CPU) 2803, a read only memory (ROM) 2806, a random access memory (RAM) 2805, and/or an interface bus 2807, and most frequently, although not necessarily, are all interconnected and/or communicating through a system bus 2804. Optionally, the computer systemization may be connected to an internal power source 2886. Optionally, a cryptographic processor 2826 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the Procurer controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 2886 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2886 is connected to at least one of the interconnected subsequent components of the Procurer thereby providing an electric current to all subsequent components. In one example, the power source 2886 is connected to the system bus component 2804. In an alternative embodiment, an outside power source 2886 is provided through a connection across the I/O 2808 interface. For example, a USB and/or IEEE 1394 connection carries both data and power across the connection and is therefore a suitable source of power.

Interface Adapters

Interface bus(ses) 2807 may accept, connect, and/or communicate to a number of interface adapters, conventionally although not necessarily in the form of adapter cards, such as but not limited to: input output interfaces (I/O) 2808, storage interfaces 2809, network interfaces 2810, and/or the like. Optionally, cryptographic processor interfaces 2827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2809 may accept, communicate, and/or connect to a number of storage devices such as, but not limited to: storage devices 2814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2810 may accept, communicate, and/or connect to a communications network 2813. Through a communications network 113, the Procurer controller is accessible through remote clients 2833b (e.g., computers with web browsers) by users 2833a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2810 may be used to engage with various communications network types 2813. For example, multiple network interfaces may be employed to allow for the communication over broadcast, multicast, and/or unicast networks.

Input Output interfaces (I/O) 2808 may accept, communicate, and/or connect to user input devices 2811, peripheral devices 2812, cryptographic processor devices 2828, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set 145, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 2811 may be card readers, dongles, finger print readers, gloves, graphics tablets, joysticks, keyboards, mouse (mice), remote controls, retina readers, trackballs, trackpads, and/or the like.

Peripheral devices 2812 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Procurer controller may be embodied as an embedded, dedicated, and/or monitor-less (i.e., headless) device, wherein access would be provided over a network interface connection.

Cryptographic units such as, but not limited to, microcontrollers, processors 2826, interfaces 2827, and/or devices 2828 may be attached, and/or communicate with the Procurer controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 2829. However, memory is a fungible technology and resource, thus, any number of memory embodiments may be employed in lieu of or in concert with one another. It is to be understood that the Procurer controller and/or a computer systemization may employ various forms of memory 2829. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 2829 will include ROM 2806, RAM 2805, and a storage device 2814. A storage device 2814 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

Component Collection

The memory 2829 may contain a collection of program and/or database components and/or data such as, but not limited to: operating system component(s) 2815 (operating system); information server component(s) 2816 (information server); user interface component(s) 2817 (user interface); Web browser component(s) 2818 (Web browser); database(s) 2819; mail server component(s) 2821; mail client component(s) 2822; cryptographic server component(s) 2820 (cryptographic server); the Procurer component(s) 2835; and/or the like (i.e., collectively a component collection). These components may be stored and accessed from the storage devices and/or from storage devices accessible through an interface bus. Although non-conventional program components such as those in the component collection, typically, are stored in a local storage device 2814, they may also be loaded and/or stored in memory such as: peripheral devices, RAM, remote storage facilities through a communications network, ROM, various forms of memory, and/or the like.

Operating System

The operating system component 2815 is an executable program component facilitating the operation of the Procurer controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Procurer controller to communicate with other entities through a communications network 2813. Various communication protocols may be used by the Procurer controller as a subcarrier transport mechanism for interaction, such as, but not limited to: multicast, TCP/IP, UDP, unicast, and/or the like.

Information Server

An information server component 2816 is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C# and/or .NET, Common Gateway Interface (CGI) scripts, Java, JavaScript, Practical Extraction Report Language (PERL), Hypertext Pre-Processor (PHP), pipes, Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Procurer controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the Procurer database 2819, operating systems, other program components, user interfaces, Web browsers, and/or the like.

Access to the Procurer database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Procurer. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Procurer as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/Vista (i.e., Aero)/XP, or Unix's X-Windows (e.g., which may include additional Unix graphic interface libraries and layers such as K Desktop Environment (KDE), mythTV and GNU Network Object Model Environment (GNOME)), provide a baseline and means of accessing and displaying information graphically to users.

A user interface component 2817 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 2818 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Procurer enabled nodes. The combined application may be nugatory on systems employing standard Web browsers.

Mail Server

A mail server component 2821 is a stored program component that is executed by a CPU 2803. The mail server may be a conventional Internet mail server such as, but not limited to sendmail, Microsoft Exchange, and/or the. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the Procurer.

Access to the Procurer mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 2822 is a stored program component that is executed by a CPU 2803. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 2820 is a stored program component that is executed by a CPU 2803, cryptographic processor 2826, cryptographic processor interface 2827, cryptographic processor device 2828, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Procurer may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the Procurer component to engage in secure transactions if so desired. The cryptographic component facilitates the secure accessing of resources on the Procurer and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Procurer Database

The Procurer database component 2819 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Procurer database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Procurer database is implemented as a data-structure, the use of the Procurer database 2819 may be integrated into another component such as the Procurer component 2835. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2819 includes several tables 2819a-c. A users table 2819a may include fields such as, but not limited to: user ID, name, company name, title, company address, city, state, zip code, company phone, user's phone, email address, state resale certificate, opt-in selections, industry, product preferences, manufacturer preferences, facsimile number, shipping address(es), billing address(es), authorizing company official information, company federal identification number, Dun & Bradstreet number, tax status, bank information, and/or the like. A products table 2819b may include fields such as, but not limited to: product identification, SKU number, UPC number, units of measure, descriptions, specifications, product associations, price, sample availability, shipping availability special handling instructions, legal and/or regulatory requirements, pictures, drawings, blueprints, production time, and/or the like. A transactions table 2819c may include fields such as, but not limited to: transaction identification, buyer data, seller data, product data, quantity, delivery time information, manufacturer, country of origin, destination, search parameters, tariffs, shipping methods, inspections, payment facilitation methods, and/or the like. All tables may support and/or track multiple entity accounts on a Procurer system,

In one embodiment, user programs may contain various user interface primitives, which may serve to update the Procurer. Also, various accounts may require custom database tables depending upon the environments and the types of clients the Procurer may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2819a-e. The Procurer may be configured to keep track of various settings, inputs, and parameters via database controllers.

The Procurer database may communicate to and/or with other components in a component collection, including itself, and/or facilities of the like. Most frequently, the Procurer database communicates with the Procurer component, other program components, and/or the like. The database may contain, retain, and provide information regarding other nodes and data.

The Procurer Component

The Procurer component 2835 is a stored program component that is executed by a CPU. In one embodiment, the Procurer component incorporates any and/or all combinations of the aspects of the Procurer that was discussed in the previous figures. As such, the Procurer affects accessing, obtaining and the provision of information, services, transactions, and/or the like across various communications networks.

The Procurer component is configurable to access, calculate, engage, exchange, generate, identify, instruct, match, process, search, serve, store, and/or facilitate transactions to enable cross border procurement and/or the like and use of the Procurer.

The Procurer component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, WebObjects, and/or the like. In one embodiment, the Procurer server employs a cryptographic server to encrypt and decrypt communications. The Procurer component may communicate to and/or with other components in a component collection, including itself, and/or facilities of the like. Most frequently, the Procurer component communicates with the Procurer database, operating systems, other program components, and/or the like. The Procurer may contain, communicate, generate, obtain, and/or provide program component, system, user, and/or data communications, requests, and/or responses.

Distributed Procurer

The structure and/or operation of any of the Procurer node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the Procurer controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

Among the embodiments envisioned as being within the scope of the present invention are:

1. A processor-implemented method embodiment to provide an online transaction facilitation portal, comprising:

providing searchable access to a plurality of product attribute displays to a buyer;

receiving a product search query from the buyer;

retrieving a plurality of product search results corresponding to the product search query;

receiving a buyer selection of at least one product from the plurality of product search results;

querying a product profile corresponding to the selected product to extract product quantity price level, timing, and shipping information;

providing a transactional parameter selection interface to the buyer, the transactional parameter selection interface including quantity price level, timing, and shipping options corresponding to the product quantity price level, timing, and shipping information;

receiving a buyer selection of product quantity price level, timing, and shipping values via the transactional parameter selection interface;

providing the buyer selection to a logistics module, the logistics module configured to convert the quantity price level, timing, and shipping values into a landed price and delivery time; and

incorporating the landed price and delivery time into a transaction record.

2. The method of embodiment 1, further comprising:

receiving a plurality of product specifications corresponding to a plurality of products; and

generating a plurality of product attribute displays based on the plurality of product specifications.

3. The method of embodiment 1, wherein the transaction record comprises a sales quote.

4. The method of embodiment 1, wherein the transaction record comprises a purchase order.

5. The method of embodiment 4, further comprising:

providing the purchase order to the logistics module, the logistics module configured to receive the purchase order and effectuate consummation of the transaction described by the purchase order.

6. The method of embodiment 1, wherein the product quantity price level information comprises a number of units per basic purchase quantity.

7. The method of embodiment 1, wherein the product quantity price level information comprises minimum and maximum purchase quantities.

8. The method of embodiment 1, wherein the timing information comprises a manufacturer lead time.

9. The method of embodiment 1, wherein the shipping information comprises a set of shipping methods.

10. The method of embodiment 1, wherein the transactional parameter selection interface comprises a quantity price level slider widget, a timing slider widget, and a shipping slider widget.

11. A processor-implemented method embodiment to generate product ordering parameter values, comprising:

receiving a buyer selection of at least one product selected from a catalog;

querying a product database for product quantity pricing level, timing, and shipping information;

populating a transactional parameter interface with product quantity pricing level, timing, and shipping options based on the product quantity pricing level, timing, and shipping information;

providing the transactional parameter interface to the buyer;

receiving a buyer input comprising values for at least one transactional parameter; and

determining a landed product price and delivery time based on the at least one transactional parameter.

12. The method of embodiment 11, wherein the product quantity pricing level, timing, and shipping options may be set to default values prior to receipt of the buyer input.

13. The method of embodiment 12, wherein the default values are selected to minimize landed product price per unit.

14. The method of embodiment 12, wherein the default values are selected to minimize a total delivery time.

15. The method of embodiment 11, wherein the quantity pricing level information comprises a number of units per basic purchase quantity.

16. The method of embodiment 11, wherein the quantity pricing level information comprises a minimum and maximum purchase quantity.

17. The method of embodiment 11, wherein the timing information comprises a manufacturer lead time.

18. The method of embodiment 11, wherein the shipping information comprises a set of shipping methods.

19. The method of embodiment 11, wherein the transactional parameter interface includes slider widgets configured to admit buyer inputs for the product quantity pricing level, timing, and shipping options.

20. A processor-implemented method embodiment to generate a transactional parameter selection user interface, comprising:

receiving a user product selection;

querying a product profile based on the user product selection;

determining sets of acceptable product quantity pricing values, product production time values, and shipping option values based on the product profile;

providing the sets of acceptable product quantity pricing values, product production time values, and shipping option values as selectable interface elements; and

configuring the selectable interface elements to pass selected product quantity pricing values, product production time values, and shipping option values to a logistics module, the logistics module adapted to convert a product quantity pricing value, product production time value, and shipping option value into a landed product price and total delivery time.

21. The method of embodiment 20, further comprising:

providing the landed product price and total delivery time for display to a user.

22. The method of embodiment 21, wherein the landed product price and total delivery time provided for display are updated in real time in response to changes in selected product quantity pricing values, product production time values, or shipping option values.

23. The method of embodiment 20, wherein the shipping option values comprise shipping methods.

24. The method of embodiment 20, wherein the shipping option values comprise shipping times.

25. The method of embodiment 20, wherein the user product selection is selected from a listing of search results.

26. The method of embodiment 20, wherein the selectable interface elements comprise slider widgets.

27. The method of embodiment 20, wherein the selectable interface elements comprise at least one radio button menu.

28. A processor-implemented method embodiment to generate a product modification user interface, comprising:

receiving a user product selection;

querying a product profile corresponding to the user product selection;

retrieving a set of modifiable product feature identifiers from the product profile; and

providing interface elements configured to admit edits to product features corresponding to the set of modifiable product feature identifiers.

29. The method of embodiment 28, wherein the product features include a product image and the interface elements include a drawing board configured to admit user drawings on the product image.

30. The method of embodiment 29, wherein the drawing board is further configured to admit user text on the product image.

31. The method of embodiment 28, wherein the interface elements include text fields.

32. The method of embodiment 28, further comprising:

storing the edits in a product editing file; and

transmitting the product editing file to a manufacturer.

33. The method of embodiment 28, wherein the product features include a color.

34. The method of embodiment 28, wherein the product features include a size.

35. The method of embodiment 28, wherein the product features include a base material.

36. The method of embodiment 28, further comprising:

providing a text box configured to receive buyer instructions.

37. The method of embodiment 28, further comprising:

providing an upload interface element configured to admit input of at least one product specification file upload.

38. A processor-implemented method embodiment for performing project-based searches of an online product catalog, comprising:

providing an input interface element configured to receive specification of a user project identifier;

receiving a user project identifier from a user via the input interface element;

querying a project database for a project record corresponding to the user project identifier;

extracting at least one product identifier associated with the project record; and

displaying to the user at least one product corresponding to the product identifier.

39. The method of embodiment 38, further comprising:

performing a product search based on the product identifier to identify at least one product corresponding to the product identifier.

40. The method of embodiment 38, wherein the input interface element is a text box.

41. The method of embodiment 38, wherein the input interface element is a menu comprising selectable project entries.

42. The method of embodiment 38, wherein the user project identifier comprises a project name;

43. The method of embodiment 38, wherein the user project identifier comprises at least one project keyword.

44. The method of embodiment 38, wherein the input interface element comprises a clickable project icon list.

45. The method of embodiment 44, wherein the user project identifier comprises a mouse click on a clickable project icon.

46. A processor-implemented method embodiment for facilitating transactional parameter sensitive product searches, comprising:

receiving at least one product search token;

searching a product records collection to extract a plurality of product records corresponding to the at least one product search token;

querying the plurality of product records to discern at least one corresponding available transactional parameter set;

configuring at least one interface element to provide selectable transactional parameter values contained in the at least one corresponding available transactional parameter set;

receiving at least one transactional parameter value selection;

filtering the plurality of product records based on the transactional parameter value selection to generate a filtered plurality of product records; and

providing the filtered plurality of product records for display to a user.

47. The method of embodiment 46, wherein the at least one product search token comprises at least one product keyword.

48. The method of embodiment 46, wherein the at least one product search token comprises at least one manufacturer name.

49. The method of embodiment 46, wherein the at least one product search token comprises a product country of origin.

50. The method of embodiment 46, wherein the at least one corresponding available transactional parameter set comprises each of a pricing quantity range, an available lead time range, and a set of available shipping methods.

51. The method of embodiment 50, wherein the at least one interface element comprises each of a pricing quantity slider widget, a lead time slider widget, and a shipping method slider widget.

52. A system embodiment to provide an online transaction facilitation portal, comprising:

means to provide searchable access to a plurality of product attribute displays to a buyer;

means to receive a product search query from the buyer;

means to retrieve a plurality of product search results corresponding to the product search query;

means to receive a buyer selection of at least one product from the plurality of product search results;

means to query a product profile corresponding to the selected product to extract product quantity price level, timing, and shipping information;

means to provide a transactional parameter selection interface to the buyer, the transactional parameter selection interface including quantity price level, timing, and shipping options corresponding to the product quantity price level, timing, and shipping information;

means to receive a buyer selection of product quantity price level, timing, and shipping values via the transactional parameter selection interface;

means to provide the buyer selection to a logistics module, the logistics module configured to convert the quantity price level, timing, and shipping values into a landed price and delivery time; and

means to incorporate the landed price and delivery time into a transaction record.

53. A system embodiment to generate product ordering parameter values, comprising:

means to receive a buyer selection of at least one product selected from a catalog;

means to query a product database for product quantity pricing level, timing, and shipping information;

means to populate a transactional parameter interface with product quantity pricing level, timing, and shipping options based on the product quantity pricing level, timing, and shipping information;

means to provide the transactional parameter interface to the buyer;

means to receive a buyer input comprising values for at least one transactional parameter; and

means to determine a landed product price and delivery time based on the at least one transactional parameter.

54. A system embodiment to generate a transactional parameter selection user interface, comprising:

means to receive a user product selection;

means to query a product profile based on the user product selection;

means to determine sets of acceptable product quantity pricing values, product production time values, and shipping option values based on the product profile;

means to provide the sets of acceptable product quantity pricing values, product production time values, and shipping option values as selectable interface elements; and

means to configure the selectable interface elements to pass selected product quantity pricing values, product production time values, and shipping option values to a logistics module, the logistics module adapted to convert a product quantity pricing value, product production time value, and shipping option value into a landed product price and total delivery time.

55. A system embodiment to generate a product modification user interface, comprising:

means to receive a user product selection;

means to query a product profile corresponding to the user product selection;

means to retrieve a set of modifiable product feature identifiers from the product profile; and

means to provide interface elements configured to admit edits to product features corresponding to the set of modifiable product feature identifiers.

56. A system embodiment for performing project-based searches of an online product catalog, comprising:

means to provide an input interface element configured to receive specification of a user project identifier;

means to receive a user project identifier from a user via the input interface element;

means to query a project database for a project record corresponding to the user project identifier;

means to extract at least one product identifier associated with the project record; and

means to display to the user at least one product corresponding to the product identifier.

57. A system embodiment for facilitating transactional parameter sensitive product searches, comprising:

means to receive at least one product search token;

means to search a product records collection to extract a plurality of product records corresponding to the at least one product search token;

means to query the plurality of product records to discern at least one corresponding available transactional parameter set;

means to configure at least one interface element to provide selectable transactional parameter values contained in the at least one corresponding available transactional parameter set;

means to receive at least one transactional parameter value selection;

means to filter the plurality of product records based on the transactional parameter value selection to generate a filtered plurality of product records; and

means to provide the filtered plurality of product records for display to a user.

58. An apparatus embodiment to provide an online transaction facilitation portal, comprising:

a processor;

a memory in communication with the processor and containing program instructions;

an input and output in communication with the processor and memory;

wherein the processor executes program instructions contained in the memory and the program instructions comprise:
provide searchable access to a plurality of product attribute displays to a buyer;
receive a product search query from the buyer;
retrieve a plurality of product search results corresponding to the product search query;
receive a buyer selection of at least one product from the plurality of product search results;
query a product profile corresponding to the selected product to extract product quantity price level, timing, and shipping information;
provide a transactional parameter selection interface to the buyer, the transactional parameter selection interface including quantity price level, timing, and shipping options corresponding to the product quantity price level, timing, and shipping information;
receive a buyer selection of product quantity price level, timing, and shipping values via the transactional parameter selection interface;
provide the buyer selection to a logistics module, the logistics module configured to convert the quantity price level, timing, and shipping values into a landed price and delivery time; and
incorporate the landed price and delivery time into a transaction record.

59. An apparatus embodiment to generate product ordering parameter values, comprising:

a processor;

a memory in communication with the processor and containing program instructions;

an input and output in communication with the processor and memory;

wherein the processor executes program instructions contained in the memory and the program instructions comprise:
receive a buyer selection of at least one product selected from a catalog;
query a product database for product quantity pricing level, timing, and shipping information;
populate a transactional parameter interface with product quantity pricing level, timing, and shipping options based on the product quantity pricing level, timing, and shipping information;
provide the transactional parameter interface to the buyer;
receiving a buyer input comprising values for at least one transactional parameter; and
determine a landed product price and delivery time based on the at least one transactional parameter.

60. An apparatus embodiment to generate a transactional parameter selection user interface, comprising:

a processor;

a memory in communication with the processor and containing program instructions;

an input and output in communication with the processor and memory;

wherein the processor executes program instructions contained in the memory and the program instructions comprise:
receive a user product selection;
query a product profile based on the user product selection;
determine sets of acceptable product quantity pricing values, product production time values, and shipping option values based on the product profile;
provide the sets of acceptable product quantity pricing values, product production time values, and shipping option values as selectable interface elements; and
configure the selectable interface elements to pass selected product quantity pricing values, product production time values, and shipping option values to a logistics module, the logistics module adapted to convert a product quantity pricing value, product production time value, and shipping option value into a landed product price and total delivery time.

61. An apparatus embodiment to generate a product modification user interface, comprising:

a processor;

a memory in communication with the processor and containing program instructions;

an input and output in communication with the processor and memory;

wherein the processor executes program instructions contained in the memory and the program instructions comprise:
receive a user product selection;
query a product profile corresponding to the user product selection;
retrieve a set of modifiable product feature identifiers from the product profile; and
provide interface elements configured to admit edits to product features corresponding to the set of modifiable product feature identifiers.

62. An apparatus embodiment for performing project-based searches of an online product catalog, comprising:

a processor;

a memory in communication with the processor and containing program instructions;

an input and output in communication with the processor and memory;

wherein the processor executes program instructions contained in the memory and the program instructions comprise:
provide an input interface element configured to receive specification of a user project identifier;
receive a user project identifier from a user via the input interface element;
query a project database for a project record corresponding to the user project identifier;
extract at least one product identifier associated with the project record; and
display to the user at least one product corresponding to the product identifier.

63. An apparatus embodiment for facilitating transactional parameter sensitive product searches, comprising:

a processor;

a memory in communication with the processor and containing program instructions;

an input and output in communication with the processor and memory;

wherein the processor executes program instructions contained in the memory and the program instructions comprise:
receive at least one product search token;
search a product records collection to extract a plurality of product records corresponding to the at least one product search token;
query the plurality of product records to discern at least one corresponding available transactional parameter set;
configure at least one interface element to provide selectable transactional parameter values contained in the at least one corresponding available transactional parameter set;
receive at least one transactional parameter value selection;
filter the plurality of product records based on the transactional parameter value selection to generate a filtered plurality of product records; and
provide the filtered plurality of product records for display to a user.

64. A processor accessible medium embodiment to provide an online transaction facilitation portal, comprising:

processor readable instructions stored in the processor accessible medium, wherein the processor readable instructions are issuable by a processor to:
provide searchable access to a plurality of product attribute displays to a buyer;
receive a product search query from the buyer;
retrieve a plurality of product search results corresponding to the product search query;
receive a buyer selection of at least one product from the plurality of product search results;
query a product profile corresponding to the selected product to extract product quantity price level, timing, and shipping information;
provide a transactional parameter selection interface to the buyer, the transactional parameter selection interface including quantity price level, timing, and shipping options corresponding to the product quantity price level, timing, and shipping information;
receive a buyer selection of product quantity price level, timing, and shipping values via the transactional parameter selection interface;
provide the buyer selection to a logistics module, the logistics module configured to convert the quantity price level, timing, and shipping values into a landed price and delivery time; and
incorporate the landed price and delivery time into a transaction record.

65. A processor accessible medium embodiment to generate product ordering parameter values, comprising:

processor readable instructions stored in the processor accessible medium, wherein the processor readable instructions are issuable by a processor to:
receive a buyer selection of at least one product selected from a catalog;
query a product database for product quantity pricing level, timing, and shipping information;
populate a transactional parameter interface with product quantity pricing level, timing, and shipping options based on the product quantity pricing level, timing, and shipping information;
provide the transactional parameter interface to the buyer;
receive a buyer input comprising values for at least one transactional parameter; and
determine a landed product price and delivery time based on the at least one transactional parameter.

66. A processor accessible medium embodiment to generate a transactional parameter selection user interface, comprising:

processor readable instructions stored in the processor accessible medium, wherein the processor readable instructions are issuable by a processor to:
receive a user product selection;
query a product profile based on the user product selection;
determine sets of acceptable product quantity pricing values, product production time values, and shipping option values based on the product profile;
provide the sets of acceptable product quantity pricing values, product production time values, and shipping option values as selectable interface elements; and
configure the selectable interface elements to pass selected product quantity pricing values, product production time values, and shipping option values to a logistics module, the logistics module adapted to convert a product quantity pricing value, product production time value, and shipping option value into a landed product price and total delivery time.

67. A processor accessible medium embodiment to generate a product modification user interface, comprising:

processor readable instructions stored in the processor accessible medium, wherein the processor readable instructions are issuable by a processor to:
receive a user product selection;
query a product profile corresponding to the user product selection;
retrieve a set of modifiable product feature identifiers from the product profile; and
provide interface elements configured to admit edits to product features corresponding to the set of modifiable product feature identifiers.

68. A processor accessible medium embodiment for performing project-based searches of an online product catalog, comprising:

processor readable instructions stored in the processor accessible medium, wherein the processor readable instructions are issuable by a processor to:
provide an input interface element configured to receive specification of a user project identifier;
receive a user project identifier from a user via the input interface element;
query a project database for a project record corresponding to the user project identifier;
extract at least one product identifier associated with the project record; and
display to the user at least one product corresponding to the product identifier.

69. A processor accessible medium embodiment for facilitating transactional parameter sensitive product searches, comprising:

processor readable instructions stored in the processor accessible medium, wherein the processor readable instructions are issuable by a processor to:
receive at least one product search token;
search a product records collection to extract a plurality of product records corresponding to the at least one product search token;
query the plurality of product records to discern at least one corresponding available transactional parameter set;
configure at least one interface element to provide selectable transactional parameter values contained in the at least one corresponding available transactional parameter set;
receive at least one transactional parameter value selection;
filter the plurality of product records based on the transactional parameter value selection to generate a filtered plurality of product records; and
provide the filtered plurality of product records for display to a user.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A processor-implemented method to generate a product modification user interface, comprising:
receiving a user product selection;
querying a product profile corresponding to the user product selection;
retrieving a set of modifiable product feature identifiers from the product profile; and
providing interface elements configured to admit edits to product features corresponding to the set of modifiable product feature identifiers.

2. The method of claim 1, wherein the product features include a product image and the interface elements include a drawing board configured to admit user drawings on the product image.

3. The method of claim 2, wherein the drawing board is further configured to admit user text on the product image.

4. The method of claim 1, wherein the interface elements include text fields.

5. The method of claim 1, further comprising:
storing the edits in a product editing file; and
transmitting the product editing file to a manufacturer.

6. The method of claim 1, wherein the product features include a color.

7. The method of claim 1, wherein the product features include a size.

8. The method of claim 1, wherein the product features include a base material.

9. The method of claim 1, further comprising:
providing a text box configured to receive buyer instructions.

10. The method of claim 1, further comprising:
providing an upload interface element configured to admit input of at least one product specification file upload.

11. A system to generate a product modification user interface, comprising:
means to receive a user product selection;
means to query a product profile corresponding to the user product selection;
means to retrieve a set of modifiable product feature identifiers from the product profile; and
means to provide interface elements configured to admit edits to product features corresponding to the set of modifiable product feature identifiers.

12. An apparatus to generate a product modification user interface, comprising:
a processor;
a memory in communication with the processor and containing program instructions;
an input and output in communication with the processor and memory;
wherein the processor executes program instructions contained in the memory and the program instructions comprise:
receive a user product selection;
query a product profile corresponding to the user product selection;
retrieve a set of modifiable product feature identifiers from the product profile; and
provide interface elements configured to admit edits to product features corresponding to the set of modifiable product feature identifiers.

13. The apparatus of claim 12, wherein the product features include a product image and the interface elements include a drawing board configured to admit user drawings on the product image.

14. The apparatus of claim 13, wherein the drawing board is further configured to admit user text on the product image.

15. The apparatus of claim 12, wherein the interface elements include text fields.

16. The apparatus of claim 12, further comprising:
store the edits in a product editing file; and
transmit the product editing file to a manufacturer.

17. The apparatus of claim 12, wherein the product features include a color.

18. The apparatus of claim 12, wherein the product features include a size.

19. The apparatus of claim 12, wherein the product features include a base material.

20. The apparatus of claim 12, further comprising:
provide a text box configured to receive buyer instructions.

21. The apparatus of claim 12, further comprising:
provide an upload interface element configured to admit input of at least one product specification file upload.

22. A processor accessible medium to generate a product modification user interface, comprising:
processor readable instructions stored in the processor accessible medium, wherein the processor readable instructions are issuable by a processor to:
receive a user product selection;
query a product profile corresponding to the user product selection;
retrieve a set of modifiable product feature identifiers from the product profile; and
provide interface elements configured to admit edits to product features corresponding to the set of modifiable product feature identifiers.

23. The medium of claim 22, wherein the product features include a product image and the interface elements include a drawing board configured to admit user drawings on the product image.

24. The medium of claim 23, wherein the drawing board is further configured to admit user text on the product image.

25. The medium of claim 22, wherein the interface elements include text fields.
